(19) United States
(12) Patent Application Publication
(10) Pub. No.: US 2023/0153405 A1
(43) Pub. Date: May 18, 2023

(54) INFORMATION PROCESSING DEVICE, INFORMATION PROCESSING SYSTEM, INFORMATION PROCESSING METHOD, AND RECORDING MEDIUM

(71) Applicant: NEC Corporation, Minato-ku, Tokyo (JP)

(72) Inventors: Kenji IIDA, Tokyo (JP); Yuki OHNO, Tokyo (JP)

(73) Assignee: NEC Corporation, Minato-ku, Tokyo (JP)

(21) Appl. No.: 17/802,672

(22) PCT Filed: Feb. 12, 2021
(86) PCT No.: PCT/JP2021/005285

§ 371 Date: Aug. 26, 2022

(30) Foreign Application Priority Data
Mar. 26, 2020 (JP) 2020-056503

(51) Int. Cl. G06F 21/31

(52) U.S. Cl. CPC G06F 21/316

(57) ABSTRACT

In order to provide authentication technology having enhanced convenience and safety, and a reduced throughput, a mobile terminal device comprises: an acquisition unit which acquires action history information indicating an action history of a subject and input information indicating input content input to questions pertaining to the action of the subject; and an authentication data generation unit which generates authentication data pertaining to the subject with reference to the action history information and the input information.

### TECHNICAL FIELD

The present invention relates to an information processing device, an information processing system, an information processing method, a control program, and a recording medium that perform processing related to authentication of a target person.

### BACKGROUND ART

Systems performing authentication on a person are generally widespread. While the authentication technology is used for identifying an individual and performing personal identification, various authentication techniques exist in the technology. A technology of performing authentication, based on a password input by a user is known as one of the most common authentication technologies. Since the technology requires a user to input a password every time in principle, there is an issue of deterioration in user convenience. Further, there is another issue of deterioration in security due to reuse of password, spoofing, and the like.

Aiming at resolution of the issues as described above, for example, PTLs 1 and 2 disclose authentication methods using a behavior history of a target person.

### CITATION LIST

### Patent Literature

PTL 1: Japanese Unexamined Patent Application Publication No. 2019-109556
PTL 2: Japanese Unexamined Patent Application Publication No. 2018-156396

### SUMMARY OF INVENTION

### Technical Problem

While effects such as improved convenience due to elimination of the necessity for password input and a reduced spoofing risk can be expected of the aforementioned conventional technologies using a behavior history of a target person, there is an issue that a large amount of processing is required in an information processing device in order for a model performing user authentication processing based on a behavior history to undergo learning.

An object of an aspect of the present invention is to provide an authentication technology reducing an amount of processing while enhancing convenience and security, by using a behavior history of a target person.

### Solution to Problem

In order to resolve the issues described above, an information processing device according to an aspect of the present invention includes: an acquisition unit acquiring behavior history information indicating a behavior history of a target person and input information indicating an input content input in response to a question related to a behavior of the target person; and an authentication data generation unit generating authentication data related to the target person with reference to the behavior history information and the input information.

Further, in order to resolve the issues described above, an information processing device according to an aspect of the present invention includes an acquisition unit and a checking unit, wherein the acquisition unit acquires first authentication data being related to a target person and being generated with reference to behavior history information indicating a behavior history of the target person at a past certain point in time and input information input in response to a question related to a behavior of the target person and second authentication data being related to a target person and being generated with reference to behavior history information indicating a behavior history of the target person at a point in time later than the certain point in time and the input information, and the checking unit checks the first authentication data against the second authentication data.

Further, in order to resolve the issues described above, an information processing system according to an aspect of the present invention includes a first information processing device and a second information processing device that are communicably connected to each other, wherein the first information processing device includes: an acquisition unit acquiring behavior history information indicating a behavior history of a target person and input information indicating an input content input in response to a question related to a behavior of the target person; and an authentication data generation unit generating authentication data related to the target person with reference to the behavior history information and the input information, the second information processing device includes a storage unit storing first authentication data being related to the target person and being generated by the authentication data generation unit with reference to behavior history information indicating a behavior history of the target person at a past certain point in time and input information indicating an input content input in response to a question related to a behavior of the target person, and the first information processing device acquires, by the acquisition unit, the first authentication data and second authentication data being related to a target person and being generated by the authentication data generation unit with reference to behavior history information indicating a behavior history of the target person at a point in time later than the certain point in time and the input information and further includes a checking unit checking the first authentication data against the second authentication data.

Further, in order to resolve the issues described above, an information processing method according to an aspect of the present invention includes: an acquisition step of acquiring behavior history information indicating a behavior history of a target person and input information indicating an input content input in response to a question related to a behavior of the target person; and a generation step of generating authentication data related to the target person with reference to the behavior history information and the input information.

Further, in order to resolve the issues described above, an information processing method according to an aspect of the present invention includes an acquisition step and a checking step, wherein, in the acquisition step, first authentication data being related to a target person and being generated with reference to behavior history information indicating a behavior history of the target person at a past certain point in time and input information indicating an input content input in response to a question related to a behavior of the target person and second authentication data being related to a target person and being generated with reference to behavior history information indicating a behavior history of the target person at a point in time later than the certain point in time and the input information are acquired, and, in the checking step, the first authentication data are checked against the second authentication data.

### Advantageous Effects of Invention

An aspect of the present invention can provide an authentication technology reducing an amount of processing while enhancing convenience and security.

### BRIEF DESCRIPTION OF DRAWINGS

FIG. 1 is a block diagram illustrating an example of a main configuration of an information processing system according to a first example embodiment.

FIG. 2 is a diagram illustrating an example of behavior history information generated by a behavior history information generation unit according to the first example embodiment.

FIG. 3 is a sequence diagram illustrating a flow of master data generation and storage processing in the information processing system according to the first example embodiment.

FIG. 4 is a diagram illustrating an example of questions presented by a presentation unit according to the first example embodiment, an example of input information indicating an input content input by a target person in response to the questions, and a re-presentation example of questions.

FIG. 5 is a flowchart illustrating a first example of authentication data generation processing by an authentication data generation unit according to the first example embodiment.

FIG. 6 is a diagram illustrating a classification processing example by hierarchical branching according to the first example embodiment, a generated authentication data example 1-1, and a generated authentication data example 1-2.

FIG. 7 is a flowchart illustrating a second example of the authentication data generation processing by the authentication data generation unit according to the first example embodiment.

FIG. 8 is a diagram illustrating an example of behavior history information after reduction by the authentication data generation unit according to the first example embodiment and a generated authentication data example 2.

FIG. 9 is a flowchart illustrating a third example of the authentication data generation processing by the authentication data generation unit according to the first example embodiment.

FIG. 10 is a diagram illustrating an authentication data example 3 according to the first example embodiment.

FIG. 11 is a flowchart illustrating a flow of authentication data update processing by a mobile terminal device according to the first example embodiment.

FIG. 12 is a sequence diagram illustrating a flow of authentication processing related to a target person, the processing using the information processing system according to the first example embodiment.

FIG. 13 is a block diagram illustrating an example of a main configuration of an information processing system according to a second example embodiment.

FIG. 14 is a sequence diagram illustrating a flow of authentication processing related to a target person, the processing using the information processing system according to the second example embodiment.

FIG. 15 is a block diagram illustrating an example of a main configuration of an information processing system according to a third example embodiment.

FIG. 16 is a sequence diagram illustrating a flow of master data generation and storage processing using the information processing system according to the third example embodiment.

FIG. 17 is a block diagram illustrating a configuration of an information processing device according to the fourth example embodiment.

FIG. 18 is a block diagram illustrating a configuration of an information processing device according to a fifth example embodiment.

FIG. 19 is a block diagram illustrating a configuration of an information processing system according to a sixth example embodiment.

FIG. 20 is a block diagram illustrating a configuration of a computer usable as the information processing device according to each example embodiment and the like.

### EXAMPLE EMBODIMENT

### First Example Embodiment

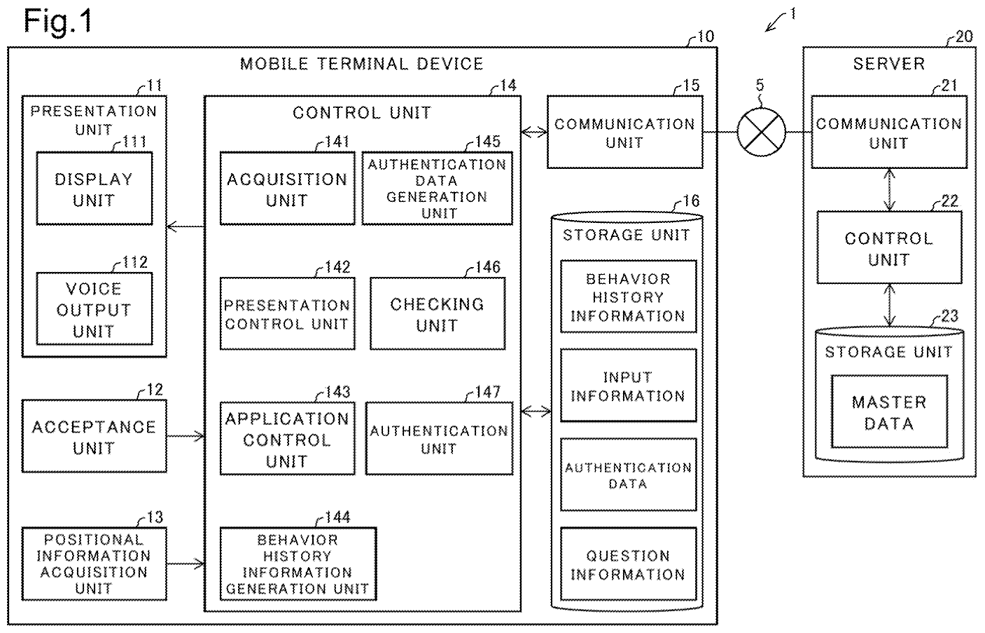

An information processing system 1 according to an example embodiment of the present invention will be described with reference to FIG. 1 to FIG. 12.

### Outline of Information Processing System 1

The information processing system 1 according to the present example embodiment is a system performing authentication of a target person of authentication processing (hereinafter simply referred to as a target person) by generating authentication data related to the target person and performing checking processing using the generated authentication data.

More specifically, the information processing system 1 is a system performing authentication of a target person by preregistering authentication data generated with reference to a behavior history of the target person as master data and then checking authentication data successively updated based on the behavior history of a target person against the master data.

As an example, the information processing system 1 is applicable to authentication processing when a target person receives a service provided by a service providing server; however, the present example embodiment is not limited to the above and, for example, may be applied to authentication processing when a target person enters a predetermined area or may be applied to authentication processing for another purpose.

### Schematic Configuration of Information Processing System 1

First, a configuration of the information processing system 1 will be described with reference to FIG. 1. FIG. 1 is a block diagram illustrating an example of a main configuration of the information processing system 1 according to the present example embodiment. The information processing system 1 is configured to include a plurality of information processing devices; and as an example, the information processing system 1 includes a mobile terminal device 10 being an information processing device and a server 20 being an information processing device, as illustrated in FIG. 1. As an example, the mobile terminal device 10 is a portable terminal device used by a target person, examples of the device including a smartphone and a tablet-type terminal device.

Further, the mobile terminal device 10 and the server 20 are configured to be communicable with each other through a network 5. While examples of the network 5 include a wide area communication network such as the Internet or a mobile communication network, the present example embodiment is not limited to the above and may be a local communication network such as a local area network (LAN), a dedicated communication circuit network, or the like.

Further, while one mobile terminal device is illustrated in FIG. 1 as an example, the present example embodiment is not limited to the above, and the information processing system 1 may be configured to include a plurality of mobile terminal devices each configured similarly to the mobile terminal device 10.

As an example, the mobile terminal device 10 includes a presentation unit 11, an acceptance unit 12, a positional information acquisition unit 13, a control unit 14, a communication unit 15, and a storage unit 16, as illustrated in FIG. 1.

The presentation unit 11 is configured to present a target person with a presentation content indicated by presentation information supplied from the control unit 14 and, as an example, includes a display unit 111 and a voice output unit 112, as illustrated in FIG. 1. The display unit 111 is for displaying an image and text as presentation contents and is configured to include a liquid crystal display panel, as an example. The voice output unit 112 is for outputting a voice as a presentation content and is configured to include a speaker with a diaphragm, as an example.

The acceptance unit 12 accepts input by an operation from a target person and generates input information indicating the accepted input content. The input information generated by the acceptance unit 12 is supplied to the control unit 14 and is also stored into the storage unit 16. As an example, the acceptance unit 12 may be configured to include a touch panel or a keyboard and accept input by a touch operation or a keyboard operation from a target person or may be configured to include a microphone and a voice analysis unit and accept input by a voice from a target person.

The positional information acquisition unit 13 acquires positional information indicating the position of the mobile terminal device 10 and supplies the acquired positional information to a behavior history information generation unit 144 included in the control unit 14. As an example, the positional information acquisition unit 13 is configured to include a reception device conforming to the Global Positioning System (GPS) and periodically acquires positional information indicating the position of the mobile terminal device 10. Further, the positional information acquisition unit 13 may be configured to be provided with information such as reception strength of a WiFi (registered trademark) signal and/or reception strength of a Bluetooth (registered trademark) signal from the communication unit 15 to be described later, specify the position of the mobile terminal device 10 by referring to the information, and generate positional information indicating the specified position.

The control unit 14 is for controlling the units included in the mobile terminal device 10 and is configured with a central processing unit (CPU), a dedicated processor, or the like. The control unit 14 provides a function based on each block included in the control unit 14 by reading and executing a control program for performing control of the mobile terminal device 10, the program being stored in the storage unit 16. Blocks included in the control unit 14 will be described later.

The communication unit 15 communicates with a communication unit 21 included in the server 20 through the network 5. As an example, the communication unit 15 is configured to include a transmission-reception device conforming to a wide area communication standard such as so-called 4G or 5G; however, the present example embodiment is not limited to the above, and the communication unit 15 may be configured to include a transmission-reception device conforming to another wide area communication standard. Further, the communication unit 15 may be configured to further include a transmission-reception device conforming to the WiFi method and/or the Bluetooth method as short-distance communication.

The storage unit 16 stores various types of data referred to by the control unit 14 and includes a random access memory (RAM), a read only memory (ROM), and the like. As an example, the storage unit 16 stores behavior history information and input information that are referred to by an authentication data generation unit 145 to be described later. Further, the storage unit 16 stores authentication data generated by the authentication data generation unit 145 to be described later and question information indicating a question presented by the presentation unit 11. Further, the storage unit 16 stores a user ID for distinguishing a target person being a user of the mobile terminal device 10 from other users, among users of the information processing system 1.

### Control Unit 14

Next, functions provided by the control unit 14 will be described with reference to FIG. 1. As an example, the control unit 14 includes an acquisition unit 141, a presentation control unit 142, an application control unit 143, the behavior history information generation unit 144, the authentication data generation unit 145, a checking unit 146, and an authentication unit 147, as illustrated in FIG. 1.

The acquisition unit 141 acquires data supplied from the units included in the mobile terminal device 10. As an example, the acquisition unit 141 acquires behavior history information indicating a behavior history of a target person from the storage unit 16 and acquires input information input in response to a question related to a behavior of the target person from the acceptance unit 12 or the storage unit 16. The aforementioned input information acquired by the acquisition unit 141 may be information accepted by a device other than the mobile terminal device 10.

The presentation control unit 142 is configured to control the presentation unit 11 and, for example, supplies presentation information to the presentation unit 11. As an example, the presentation control unit 142 supplies question information stored in the storage unit 16 to the presentation unit 11.

The application control unit 143 controls various applications. As an example, the application control unit 143 starts and ends various applications and supplies data to various applications, in response to an operation from a target person.

Further, as an example, the application control unit 143 successively generates an application usage history by associating a date and time when an application is started, a date and time when the application is ended, and identification information of the application with each other and successively supplies the generated application usage history to the behavior history information generation unit 144.

The behavior history information generation unit 144 successively generates behavior history information indicating a behavior history of a target person and stores the generated behavior history information into the storage unit 16. As an example, the behavior history information generation unit 144 refers to a latest positional information history supplied from the positional information acquisition unit 13 and a latest application usage history supplied from the application control unit 143, generates behavior history information including the latest positional information history and the latest application usage history, and stores the behavior history information into the storage unit 16.

As an example, generation and storage of behavior history information by the behavior history information generation unit 144 is successively performed for every predetermined period P1. While a specific value of the predetermined period P1 does not limit the present example embodiment, a value in a range from about 1 second to about 10 minutes may be employed as an example.

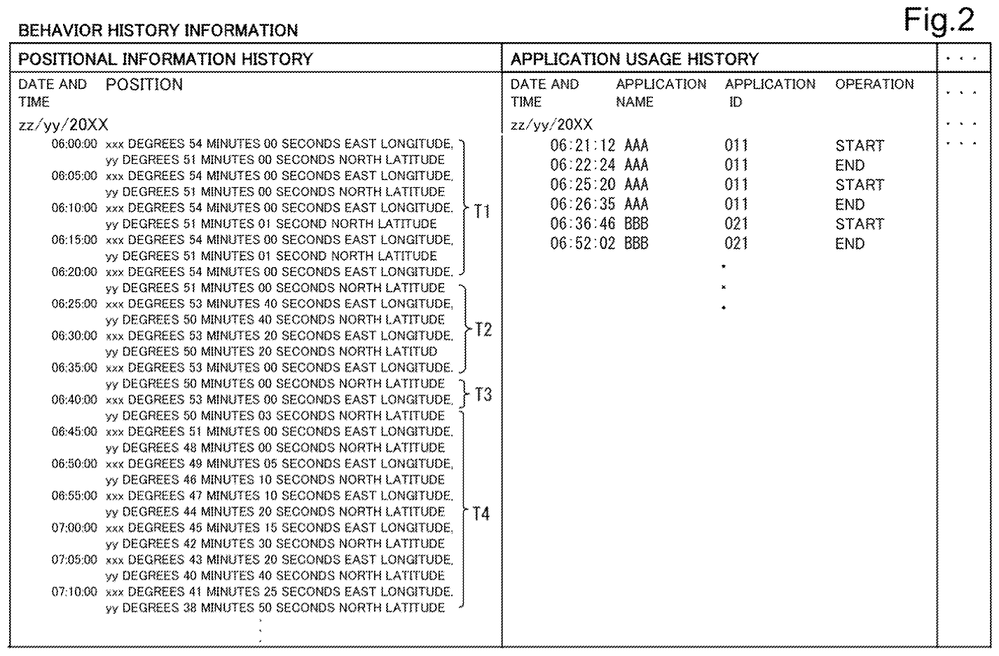

FIG. 2 is a diagram illustrating an example of behavior history information generated by the behavior history information generation unit 144. As illustrated in FIG. 2, the behavior history information includes a positional information history, and an application usage history. In the example illustrated in FIG. 2, the positional information history includes the longitude and latitude of the mobile terminal device 10 for every 5 minutes being a predetermined period, and the application usage history includes a time, an application name, an application ID, and an operation in association with each other. The application ID is identification information for distinguishing applications from each other.

While an example of behavior history information including a positional information history and an application usage history is described above, the present example embodiment is not limited to the above. As an example, the behavior history information generation unit 144 may be configured to acquire a latest browsing history of a target person at a website and a latest purchase history of the target person at an electronic commerce site from the application control unit 143 and generate behavior history information including the acquired browsing history and the acquired purchase history.

Further, the behavior history information generation unit 144 may be configured to acquire a latest WiFi connection history and an IP address assignment history from the communication unit 15 and generate behavior history information including the acquired connection history and the acquired assignment history.

Further, the behavior history information generation unit 144 may be configured to acquire a history of sensor values from various sensors included in the mobile terminal device 10, such as an acceleration sensor and an illuminance sensor, and generate behavior history information including the acquired history of sensor values.

The authentication data generation unit 145 generates authentication data related to the target person with reference to behavior history information and input information that are stored in the storage unit 16. The authentication data generation unit 145 generates authentication data with reference to behavior history information and therefore can improve convenience and security compared with a case without reference to behavior history information. Further, the authentication data generation unit 145 generates authentication data with reference to not only behavior history information but also input information and therefore reduces an amount of processing required for generation of authentication data compared with a configuration in which only behavior history information is referred to. As an example, an amount of processing required for generation of authentication data is reduced compared with a configuration in which a classification model undergoes learning by using behavior history information and a target person is classified by using the classification model undergoing learning.

Authentication data generated by the authentication data generation unit 145 are stored into the storage unit 16. Specific generation processing of authentication data by the authentication data generation unit 145 will be described later.

The checking unit 146 checks master data generated at a past certain point in time acquired by the acquisition unit 141 against authentication data generated at a point in time later than the certain point in time. Then, the checking unit 146 supplies information indicating the checking result to the authentication unit 147.

As an example, the checking unit 146 checks master data being acquired by the acquisition unit 141 and being first authentication data against second authentication data acquired by the acquisition unit 141, the first authentication data being related to a target person and being generated by the authentication data generation unit 145 with reference to behavior history information indicating a behavior history of the target person at a past certain point in time and input information indicating an input content input in response to a question related to a behavior of the target person, and the second authentication data being related to a target person and being generated by the authentication data generation unit 145 with reference to behavior history information indicating a behavior history of the target person at a point in time later than the certain point in time and the input information. Note that behavior history information indicating a behavior history of a target person at a certain point in time includes a history of a behavior of the target person at a time point earlier than the certain point in time. Specific checking processing by the checking unit 146 will be described later.

The authentication unit 147 determines whether to authenticate a target person with reference to a checking result by the checking unit 146. Then, the authentication unit 147 generates information to the effect that authentication is performed when authenticating the target person and generates information to the effect that authentication is not performed when not authenticating the target person. Specific authentication processing by the authentication unit 147 will be described later.

An configuration including the acquisition unit 141 and the checking unit 146 illustrated in FIG. 1 may be referred to as a checking device.

### Schematic Configuration of Server 20

As illustrated in FIG. 1, the server 20 includes a communication unit 21, a control unit 22, and a storage unit 23.

The communication unit 21 communicates with the communication unit 15 included in the mobile terminal device 10 through the network 5. While the communication unit 21 is configured to include a transmission-reception device conforming to a wide area communication standard such as so-called 4G or 5G, the present example embodiment is not limited to the above and may be configured to include a transmission-reception device conforming to another wide area communication standard. Further, the communication unit 21 may be configured to further include a transmission-reception device conforming to the WiFi method and/or the Bluetooth method as short-distance communication.

The control unit 22 is for controlling the units included in the server 20 and is configured with a CPU, a dedicated processor, or the like. The control unit 22 provides a function based on each block included in the control unit 22 by reading and executing a control program for performing control of the server 20, the program being stored in the storage unit 23. The storage unit 23 stores various types of data referred to by the control unit 22 and includes a RAM, a ROM, and the like.

As an example, the control unit 22 stores master data acquired through the communication unit 21 into the storage unit 23. Further, the control unit 22 reads the master data from the storage unit 23 in response to a request from the mobile terminal device 10 and supplies the read master data to the mobile terminal device 10 through the communication unit 21.

### Master Data Generation and Storage Processing

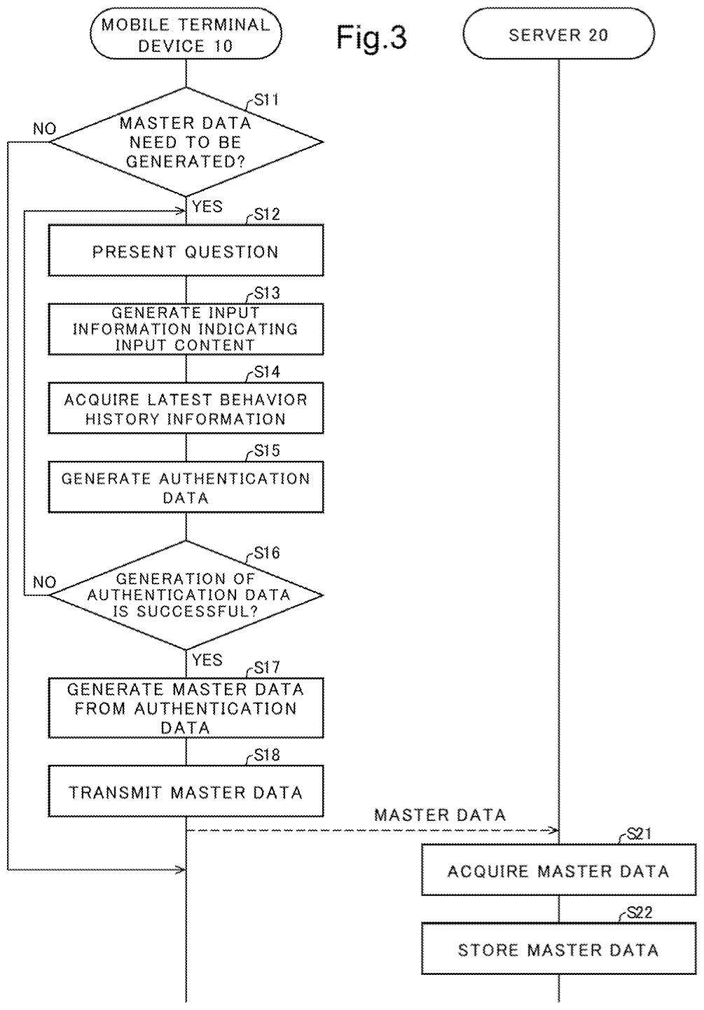

Next, a flow of master data generation and storage processing in the information processing system 1 will be described with reference to FIG. 3. FIG. 3 is a sequence diagram illustrating a flow of the master data generation and storage processing in the information processing system 1 according to the present example embodiment.

### Step S11

First, in Step S11, the control unit 14 determines whether master data need to be generated. As an example, the control unit 14 determines that master data do not need to be generated when master data are already generated in the past and determines that master data need to be generated when master data are not already generated in the past. As an example, the control unit 14 can confirm whether master data are generated in the past by referring to a master data generation history stored in the storage unit 16.

The control unit 14 advances to Step S12 when determining that master data need to be generated (YES in Step S11) and does not generate master data when determining that master data do not need to be generated (NO in Step S11).

Determination of whether generation of master data is required by the control unit 14 is not limited to the example described above; and for example, the control unit 14 may determine that master data need to be generated when referring to a master data generation history stored in the storage unit 16 and confirming elapse of a certain period after the previous generation of master data. Alternatively, the control unit 14 may determine that master data need to be generated when the acceptance unit 12 accepts an instruction to generate master data from a target person.

### Step S12

Next, in Step S12, the presentation control unit 142 reads question information from the storage unit 16 and causes the presentation unit 11 to present a question being indicated by the read question information and being related to a behavior of the target person. The presentation unit 11 may present the question by display through the display unit 111 or may output the question by voice through the voice output unit 112.

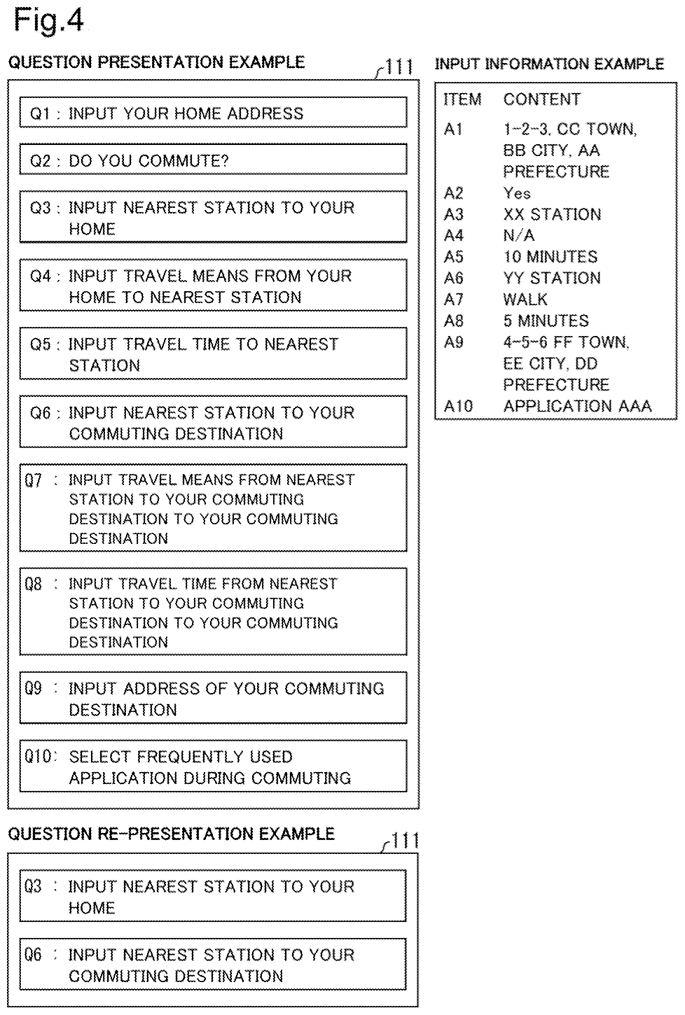

A display example of questions displayed by the display unit 111 in the presentation unit 11 is illustrated in FIG. 4. In this example, the question information includes the following 10 questions related to home being the starting point or the ending point of travel, existence of commuting, a commuting destination being the ending point or the starting point of the travel, a station being a transfer point of the travel, a travel means, a frequently used application, and the like, and the display unit 111 displays each of the 10 questions.

Q1: Input your home address.

Q2: Do you commute?

Q3: Input the nearest station to your home.

Q4: Input the travel means from your home to the nearest station.

Q5: Input the travel time to the nearest station.

Q6: Input the nearest station to your commuting destination.

Q7: Input the travel means from the nearest station to your commuting destination to your commuting destination.

Q8: Input the travel time from the nearest station to your commuting destination to your commuting destination.

Q9: Input the address of your commuting destination.

Q10: Select a frequently used application during commuting.

### Step S13

Next, in Step S13, the acceptance unit 12 accepts input from the target person and generates input information indicating an input content from the target person. The input information generated by the acceptance unit 12 is supplied to the control unit 14 and is also stored into the storage unit 16. An example of input information indicating an input content input by the target person in response to the example of questions in the diagram is illustrated in FIG. 4.

In the example illustrated in FIG. 4, the following items A1 to A10 are described as input information indicating an input content to the questions Q1 to Q10:

A1: 1-2-3 CC Town, BB City, AA Prefecture

A2: Yes

A3: XX Station

A4: N/A

A5: 10 minutes

A6: YY Station

A7: Walk

A8: 5 minutes

A9: 4-5-6, FF Town, EE City, DD Prefecture

A10: Application AAA

Note that the item A4 in the input information being “N/A” indicates no input to the question Q4 from the target person in the example illustrated in FIG. 4.

Thus, the input information in the example illustrated in FIG. 4 includes home being the starting point or the ending point of travel, existence of commuting, a commuting destination being the ending point or the starting point of the travel, a station being a transfer point of the travel, and a travel means. Input information including various types of information about travel of the target person as is the case in the aforementioned example enables effective reduction in an amount of processing in authentication data generation processing using the input information.

Further, as illustrated in the example in FIG. 4, a frequently used application can be specified by including information about the frequently used application and the like into input information without referring to an application usage history, and therefore reduction in an amount of processing when authentication data are generated is achieved.

The items included in question information and input information are not limited to the example described above, and for example, information indicating attributes of a target person, such as the age and the gender of the target person, may be included.

### Step S14

Next, in Step S14, the acquisition unit 141 acquires latest behavior history information stored in the storage unit 16. Then, the acquisition unit 141 supplies the latest behavior history information to the authentication data generation unit 145.

### Step S15

Next, in Step S15, the authentication data generation unit 145 generates authentication data related to the target person with reference to the input information generated in Step S13 and the latest behavior history information acquired in Step S14. Specific generation processing of authentication data will be described later.

When the input information is not consistent with the latest behavior history information, authentication data may not be generated in this step. Details will be described later.

### Step S16

Next, in Step S16, the authentication data generation unit 145 determines whether generation of authentication data in Step S15 is successful and advances to Step S16 when the generation is successful (YES in Step S16); and the authentication data generation unit 145 otherwise (NO in Step S16) returns to Step S12, presents the questions again, and then accepts input from the target person again.

Re-presentation of the questions in the aforementioned processing may be performed only on part of the questions presented in Step S12 as illustrated in a question re-presentation example in FIG. 4. As an example, the authentication data generation unit 145 may be configured to display only questions related to items in the input information not consistent with the behavior history information in the consistency confirmation processing executed in Step S15. For example, when the items A3 and A6 in the input information are not consistent with the behavior history information in the consistency confirmation processing in Step S15, re-presentation of only the questions Q3 and Q6 related to the items are performed, as illustrated in FIG. 4.

Further, upon re-presentation of the questions, the presentation control unit 142 may be configured to further present a message prompting the target person to re-input, such as “Input answers to Q3 and Q6 again,” through the presentation unit 11.

### Step S17

When the generation of authentication data is successful, in Step S17, the authentication data generation unit 145 generates master data from the authentication data generated in Step S15. As an example, the authentication data generation unit 145 may use the authentication data generated in Step S15 as-is as master data or, as another example, may generate master data by attaching a flag indicating master data to the authentication data generated in Step S15. The master data generated in this step are supplied to the communication unit 15. Further, the authentication data generation unit 145 stores information to the effect that master data are already generated into the storage unit 16 as a master data generation history. The master data and the master data generation history may include a time stamp indicating a date and time when the master data are generated.

### Step S18

Next, in Step S18, the communication unit 15 transmits the master data generated in Step S17 to the communication unit 21 in the server 20.

### Step S21

Next, in Step S21, the communication unit 21 in the server 20 receives the master data transmitted in Step S18 and supplies the data to the control unit 22.

### Step S22

Next, the control unit 22 acquires the master data received in Step S21 and stores the data into the storage unit 23.

In the sequence diagram illustrated in FIG. 3, the steps may be executed in an order other than the illustrated order. For example, Step S14 may be executed between Step S11 and Step S12 or may be executed between Step S12 and Step S13.

Specific authentication data generation examples are listed below.

### Example 1

Include category information or label information acquired with reference to input information into authentication data.

Behavior history information is used only for confirmation of consistency and is not included into authentication data.

### Example 2

Include category information or label information acquired with reference to input information into authentication data.

Include behavior history information after reduction processing into authentication data.

### Example 3

Include category information or label information acquired with reference to input information into authentication data.

Include second category information acquired with reference to behavior history information after reduction processing into authentication data.

### Authentication Data Generation Processing

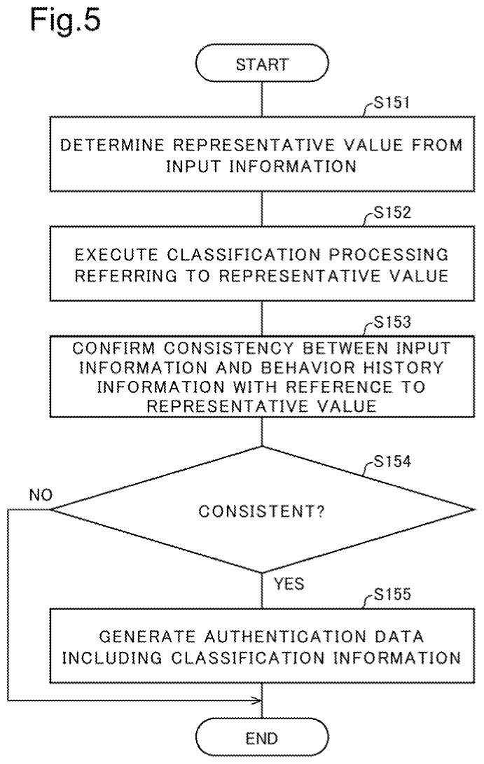

Next, authentication data generation processing examples by the authentication data generation unit 145 will be described with reference to FIG. 5 to FIG. 10.

### Authentication Data Generation Processing Example 1

First, a first example of the authentication data generation processing will be described with reference to FIG. 5. FIG. 5 is a flowchart illustrating the first example of the authentication data generation processing by the authentication data generation unit 145.

### Step S151

First, in Step S151, with reference to the input information generated by the acceptance unit 12 in Step S13, the authentication data generation unit 145 determines a representative value related to at least one item out of a plurality of items included in the input information. Such determination of a representative value enables reduction in an amount of processing in classification processing to be described later.

As an example, in order to execute processing of determining a representative value, the authentication data generation unit 145 may be configured to refer to a table in which longitude and latitude information is associated with an address, a station name, a building name, a company name, a travel means, and the like. Such a table may be previously stored in the storage unit 16, or the table stored in an external server may be accessed through the network 5.

By referring to the aforementioned table, the authentication data generation unit 145 determines, from the item A1 “1-2-3 CC Town, BB City, AA Prefecture” in the input information indicating the home address of the target person, longitude and latitude being “xxx degrees 54 minutes 00 seconds east longitude, yy degrees 51 minutes 00 seconds north latitude” indicated by the address to be a representative value related to the item A1.

Similarly, from the item A3 “XX Station” in the input information indicating the nearest station to the home of the target person, the authentication data generation unit 145 determines “xxx degrees 53 minutes 00 seconds east longitude, yy degrees 50 minutes 00 seconds north latitude” being longitude and latitude indicated by the station name to be a representative value related to the item A3.

Similarly, for the item A6 in the input information indicating the nearest station to the commuting destination of the target person, the authentication data generation unit 145 determines longitude and latitude related to the item A6 to be a representative value. Further, for the item A9 in the input information indicating the address of the commuting destination of the target person, the authentication data generation unit 145 determines longitude and latitude related to the item A9 to be a representative value.

Further, for the item related to the travel means in the input information, the authentication data generation unit 145 specifies a route of the travel means with reference to the aforementioned table and determines a set of positional information indicating the route to be a representative value.

Further, the authentication data generation unit 145 refers to the item A10 “application AAA” indicating an application frequently used by the target person during commuting and determines “AAA” being the application name of the application or an application ID “011” to be a representative value related to the item A10.

### Step S152

Next, in Step S152, the authentication data generation unit 145 executes classification processing referring to the representative value determined in Step S151. More specifically, the authentication data generation unit 145 executes the classification processing of classifying the target person as one of a plurality of categories with reference to the representative value determined in Step S151 and the latest behavior history information acquired by the acquisition unit 141 in Step S14.

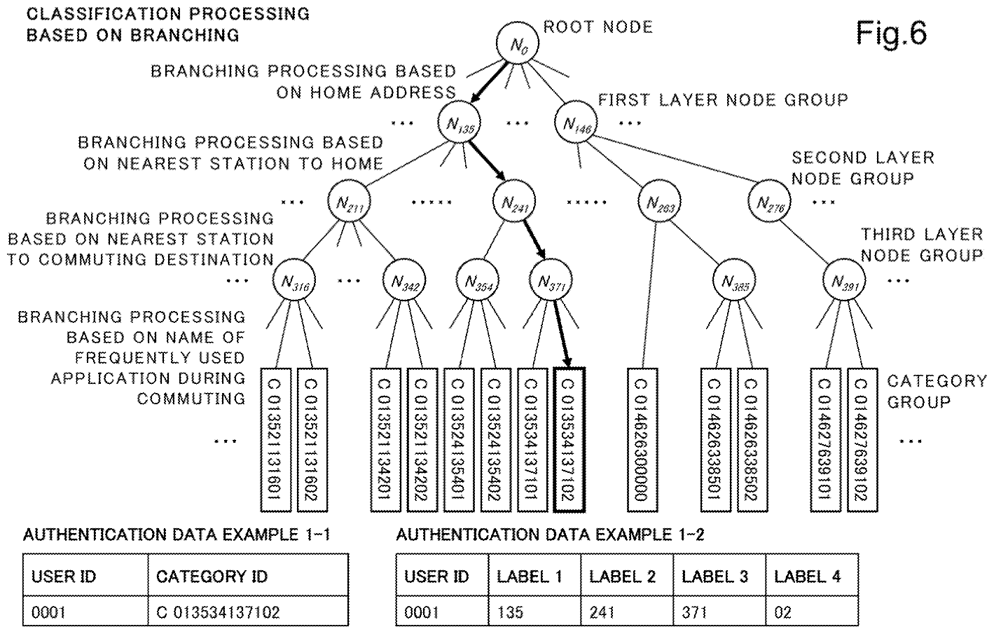

FIG. 6 is a diagram for illustrating a classification processing example in this step. FIG. 6 illustrates classification processing by hierarchical branching as the classification processing example in this step.

In the example illustrated in FIG. 6, the authentication data generation unit 145 first performs branching processing referring to the home address of the target person at a root node. More specifically, the authentication data generation unit 145 refers to longitude and latitude being the representative value of the aforementioned item A1 and performs branching to a first layer node group, based on which of a plurality of predetermined regions a position specified by the longitude and latitude is included in.

For example, the plurality of regions may be regions demarcated from each other as administrative districts such as prefectures, cities, towns, and villages or may be regions being set independently of the administrative districts (hereinafter the same).

Each node included in the first layer node group represents a branching destination of the branching processing from the root node at which the longitude and latitude being the representative value of the item A1 is referred to. Further, in FIG. 6, an index attached to each first layer node N, such as “135” or “146,” indicates an index for distinguishing nodes included in the first layer node group from each other.

Next, the authentication data generation unit 145 performs branching processing referring to the nearest station to the home in the first layer node group. More specifically, the authentication data generation unit 145 refers to longitude and latitude being the representative value of the aforementioned item A3 and performs branching to a second layer node group, based on which of a plurality of predetermined regions the longitude and latitude is included in.

Each node included in the second layer node group represents a branching destination of the branching processing from a first layer node at which the longitude and latitude being the representative value of the item A3 is referred to. Further, in FIG. 6, an index attached to each second layer node N, such as “211,” or “241,” indicates an index for distinguishing nodes included in the second layer node group from each other.

Next, the authentication data generation unit 145 performs branching processing referring to the nearest station to the commuting destination in the second layer node group. More specifically, the authentication data generation unit 145 refers to longitude and latitude of the representative value of the aforementioned item A6 and performs branching to a third layer node group, based on which of a plurality of predetermined regions the longitude and latitude is included in.

Each node included in the third layer node group represents a branching destination of the branching processing from a second layer node at which the longitude and latitude being the representative value of the item A6 is referred to. Further, in FIG. 6, an index attached to each third layer node N, such as “316,” or “342,” indicates an index for distinguishing nodes included in the third layer node group from each other.

Next, the authentication data generation unit 145 performs branching processing referring to a frequently used application name in the third layer node group. More specifically, the authentication data generation unit 145 performs branching to one of a plurality of categories included in a category group, based on which application group out of a plurality of predetermined application groups, the application name or the application ID being the representative value of the item A10 in the input information indicating a frequently used application name is included in.

For example, the application group may be a group being set according to an application type, a group being set according to an application name, or a group being set according to another criterion.

In FIG. 6, an index attached to each category, such as “C 013521131601” or “013521131602,” is a category ID for distinguishing categories included in the category group from each other and is an example of classification information to be described later. In the example in FIG. 6, the last two figures of a category ID is an index for distinguishing branches from a third layer node being a final layer node to a category from each other and has a meaning similar to that of an index of each node.

In the example illustrated in FIG. 6, by performing the branching processing as described above, the authentication data generation unit 145 classifies a target person as one of the plurality of categories included in the category group. As an example, a flow indicated by thick lines in FIG. 6 indicates a case in which the authentication data generation unit 145 starts the branching processing from the root node and classifies the target person as a category “C 013534137102” through a first layer node N135, a second layer node N241, and a third layer node N371. The number of characters in a category ID and a specific assignment rule of a category ID in FIG. 6 do not limit the present example embodiment.

Further, when the branching processing from the third layer node group to the category group is performed in this step, the representative value of the item A10 included in the input information is referred to; however, the present example embodiment is not limited to the above. The authentication data generation unit 145 may specify the “application AAA” being a frequently used application during commuting with reference to an application usage history and perform the branching processing from the third layer node group to the category group by using the application name or the application ID of the application.

### Step S153

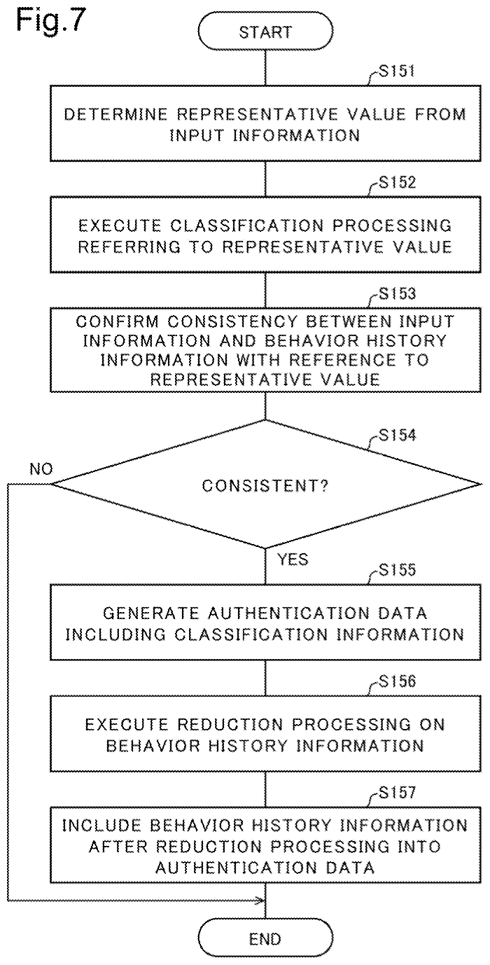

Returning to FIG. 7, in Step S153, the authentication data generation unit 145 performs processing of confirming consistency between the input information used for the classification in Step S152 and the behavior history information with reference to the representative value determined in Step S151. Such confirmation of consistency between the input information and the behavior history information by the authentication data generation unit 145 enables generation of more reliable authentication data.

As an example, first, the authentication data generation unit 145 compares “xxx degrees 54 minutes 00 seconds east longitude, yy degrees 51 minutes 00 seconds north latitude” being the representative value of the item A1 in the input information, the value being determined in Step S151, with the positional information history in the behavior history information illustrated in FIG. 2. Then, the authentication data generation unit 145 determines consistency, based on whether positional information the difference between which and the representative value falls within a predetermined range R exists in the positional information history.

The aforementioned predetermined range R may be set by the authentication data generation unit 145 as appropriate, based on a related item in the input information. For example, the authentication data generation unit 145 may be configured to set plus or minus about 1 second for both longitude and latitude as the aforementioned predetermined range R for an item in the input information being A1 “the home address,” and set plus or minus about 10 seconds for both longitude and latitude as the aforementioned predetermined range R for items in the input information being A3 “the nearest station to the home,” A6 “the nearest station to the commuting destination,” and A9 “the address of the commuting destination.” Further, for an item in the input information indicating a travel means, the authentication data generation unit 145 may set plus or minus about 1 second to the aforementioned predetermined range R as a deviation from a travel route based on the travel means.

In the example illustrated in FIG. 2, the difference between the representative value of the item A1 in the input information and positional information in a time section T1 falls within the aforementioned predetermined range R, and therefore the authentication data generation unit 145 determines that the item A1 in the input information is consistent with the time section T1 in the positional information history.

Similarly, the authentication data generation unit 145 compares “xxx degrees 53 minutes 00 seconds east longitude, yy degrees 50 minutes 00 seconds north latitude” being the representative value of the item A3 in the input information, the value being determined in Step S151, with the positional information history in the behavior history information illustrated in FIG. 2.

In the example illustrated in FIG. 2, the difference between the representative value of the item A3 in the input information and positional information in a time section T3 falls within the aforementioned predetermined range R, and therefore the authentication data generation unit 145 determines that the item A3 in the input information is consistent with the time section T3 in the positional information history.

Further, as an example, the authentication data generation unit 145 compares the application name “AAA” or the application ID “011” being the representative value of the item A10 in the input information, the value being determined in Step S151, with an application name or an application ID in a time period corresponding to time sections T2 to T4 during commuting in the application usage history illustrated in FIG. 2. Then, the authentication data generation unit 145 determines that the item A10 in the input information is consistent with the application usage history.

Thus, the authentication data generation unit 145 confirms consistency between the input information used in the classification in Step S152 and the behavior history information for each item in the input information.

### Step S154

When determining that a predetermined number of items or more, or a predetermined ratio of items or more among the items included in the input information have consistency in Step S153, the authentication data generation unit 145 determines that the input information is consistent with the behavior history information in Step S154. Then, the authentication data generation unit 145 advances to Step S155 when determining that the input information is consistent with the behavior history information (Step YES in S154) and ends this flow without generating authentication data otherwise (NO in Step S154).

The aforementioned predetermined number and the predetermined ratio can be set as appropriate, based on the required security precision.

### Step S155

In Step S155, the authentication data generation unit 145 generates authentication data including the classification information specified by the classification processing in Step S152. As the classification information, a category ID indicating a category as which the target person is classified in Step S152 can be used. Such generation of authentication data including classification information by the authentication data generation unit 145 enables reduction in an amount of processing in checking processing to be described later.

An authentication data example 1-1 being an example of authentication data generated in this authentication data generation processing example 1 is illustrated in FIG. 6. As illustrated in FIG. 6, the authentication data example 1-1 generated in this processing example includes the user ID of the target person and the category ID of a category as which the target person is classified, whereas the behavior history information generated by the behavior history information generation unit 144 is not included. Such generation of authentication data including the category ID enables reduction in an amount of processing in the checking processing to be described later. Further, generation of authentication data without including the behavior history information enables reduction in an amount of the authentication data.

Further, an authentication data example 1-2 being another example of authentication data generated in this authentication data generation processing example 1 is illustrated in FIG. 6. Since the branching processing described above is branching processing referring to a representative value in input information, and therefore an index attached to each node and an index indicating a branch from a final layer node to a category also have a meaning as label information indicating a content of at least one of one or more items included in the input information. Then, the label information has a meaning as classification information.

In place of the category ID included in the authentication data example 1-1, the authentication data example 1-2 illustrated in FIG. 6 includes an index of each node through which the target person passes in the branching processing described above and an index indicating a branch from the final layer node to the category as a label 1 to a label 4. Such inclusion of label information into authentication data in place of category information also enables reduction in an amount of processing in the checking processing to be described later.

### Authentication Data Generation Processing Example 2

Next, a second example of the authentication data generation processing will be described with reference to FIG. 7. FIG. 7 is a flowchart illustrating the second example of the authentication data generation processing by the authentication data generation unit 145.

In addition to Step S151 to Step S155 included in the authentication data generation processing example 1, the authentication data generation processing according to this example includes the following steps. Note that Step S151 to Step S155 have been already described in the authentication data generation processing example 1, and therefore description thereof is omitted.

### Step S156

In Step S156, the authentication data generation unit 145 executes reduction processing on behavior history information. More specifically, the authentication data generation unit 145 executes the reduction processing of referring to input information generated by the acceptance unit 12 in Step S13 and deleting at least part of information specified by at least one of one or more items included in the input information from the behavior history information acquired in Step S14.

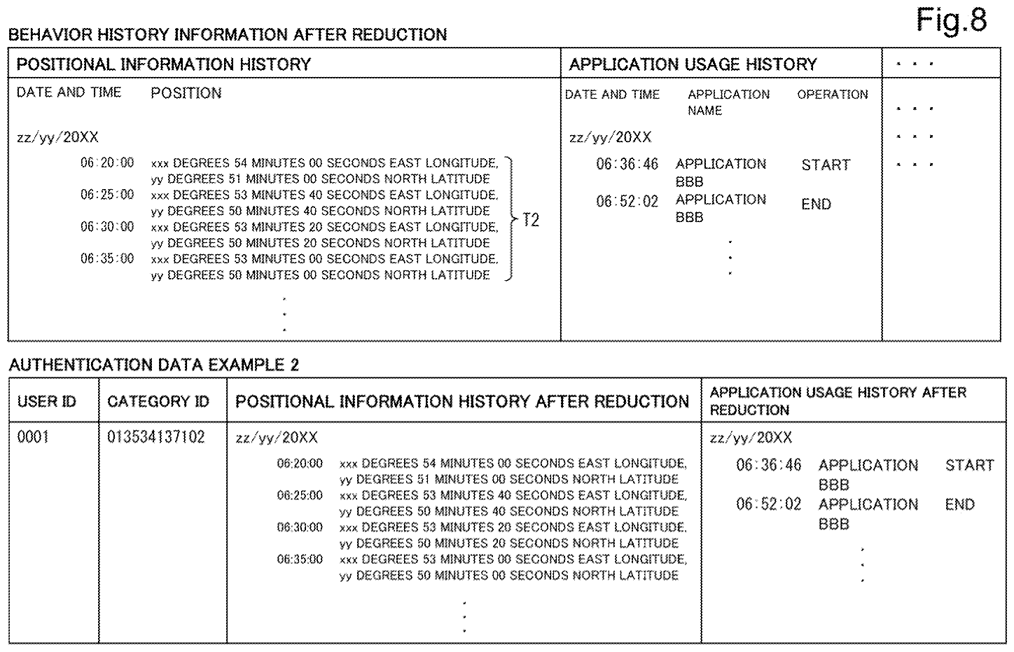

An example of behavior history information after reduction by the authentication data generation unit 145 is illustrated in FIG. 8. In the example illustrated in FIG. 8, the authentication data generation unit 145 generates the behavior history information after reduction by deleting the following information from the time sections T1 to T4 in the positional information history and the application usage history that are illustrated in FIG. 2.

the positional information history in the time section T1 being information specified by the item A1 “the home address” in the input information

the positional information history in the time section T3 being information specified by the item A3 “the nearest station to the home” in the input information

the positional information history in the time section T4 being information specified by the item A3 “the nearest station to the home” and the item A6 “the nearest station to the commuting destination” in the input information

the usage history related to the “application AAA” related to the item A10 “a frequently used application during commuting” in the input information

As an example, with respect to the item A1 in the input information, the authentication data generation unit 145 specifies, in the positional information history, a time section of positional information the difference between which and the representative value of the item, “xxx degrees 54 minutes 00 seconds east longitude, yy degrees 51 minutes 00 seconds north latitude,” falls within the aforementioned predetermined range R and deletes the specified time section T1 from the positional information history. As for deletion of another positional information history, a time section in which the difference from the representative value falls within the predetermined range may be similarly deleted from the positional information history.

With respect to the time section T1, instead of deleting the entire positional information history in the time section T1, the authentication data generation unit 145 may be configured to generate behavior history information after reduction by leaving only part of the positional information history and deleting the remainder, such as leaving only the first row. The same applies to other periods. Further, the authentication data generation unit 145 may be similarly configured to generate behavior history information after reduction by leaving only part of the usage history related to the “application AAA” and deleting the remainder.

Further, the reduction processing in this step may be expressed as processing of deleting a behavior history consistency of which with the input information in Step S153 is confirmed from the behavior history information.

### Step S157

Next, in Step S157, the authentication data generation unit 145 includes the behavior history information after reduction generated in Step S156 into the authentication data. Such inclusion of the behavior history information after reduction into the authentication data by the authentication data generation unit 145 enables reduction in an amount of the authentication data compared with a case of including the entire behavior history information. Further, the behavior history information after reduction may also be a checking target in the checking processing to be described later, and therefore precision of the checking processing is improved.

An authentication data example 2 being an example of authentication data undergoing the processing in this step S157 is illustrated in FIG. 8. As illustrated in FIG. 8, the authentication data according to this example includes the positional information history after reduction and the application usage history after reduction as the behavior history information after reduction, in addition to the target person ID of the target person and the category ID of the category as which the target person is classified.

### Authentication Data Generation Processing Example 3

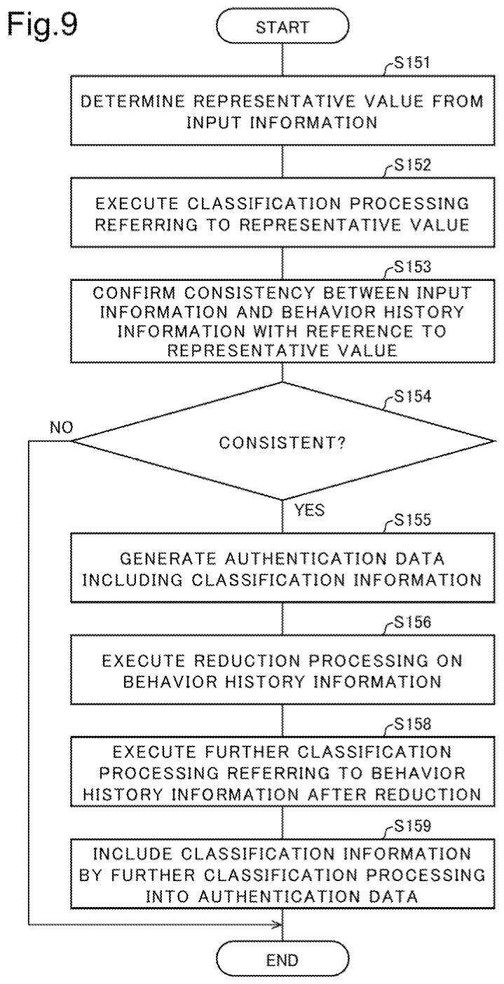

Next, a third example of the authentication data generation processing will be described with reference to FIG. 9. FIG. 9 is a flowchart illustrating the third example of the authentication data generation processing by the authentication data generation unit 145.

In addition to Step S151 to S156 included in the authentication data generation processing example 2, the authentication data generation processing according to this example includes the following steps. Note that Step S151 to Step S156 have been already described in the authentication data generation processing examples 1 and 2, and therefore description thereof is omitted.

### Step S158

In Step S158, the authentication data generation unit 145 executes further classification processing with reference to behavior history information after reduction generated in Step S156. As an example, the authentication data generation unit 145 inputs the behavior history information after reduction generated in Step S156 to a learned model and acquires further classification information about the target person as an output of the learned model.

For example, a model learned by using behavior history information of a group of users including the target person or a group of users excluding the target person may be used as the aforementioned learned model. In order to perform such learning, as an example, the server 20 is communicably connected to a plurality of mobile terminal devices other than the mobile terminal device 10 and the server 20 acquires behavior history information of each user from each of the plurality of mobile terminal devices. Then, learning of the model is performed by the server 20 by using training data using the acquired behavior history information. Then, the learned model may be supplied to the authentication data generation unit 145 by supplying various parameters for defining the learned model to the mobile terminal device 10.

### Step S159

In Step S159, the authentication data generation unit 145 includes the further classification information acquired in Step S158 into authentication data.

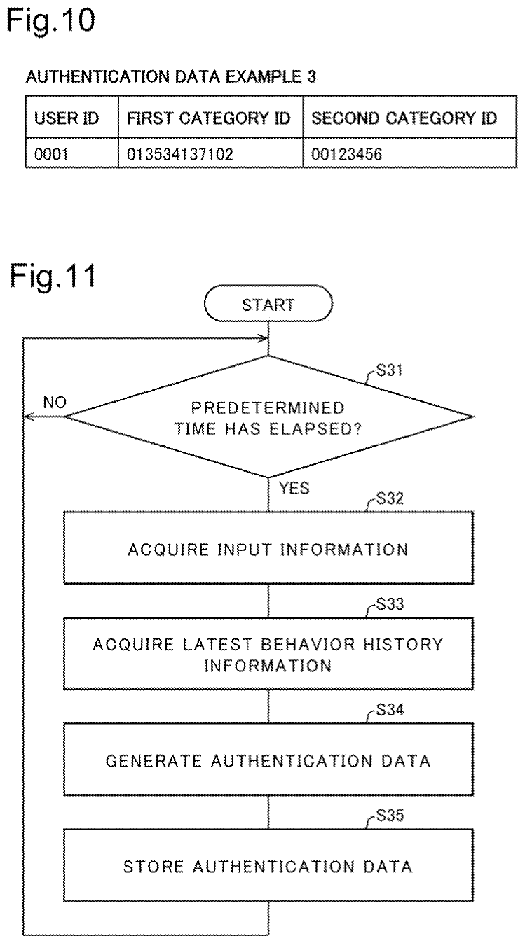

FIG. 10 illustrates an authentication data example 3 being an example of authentication data undergoing the processing in this step S159. As illustrated in FIG. 10, the authentication data according to this example include a second category ID as the classification information acquired in Step S158, in addition to the user ID of the target person and a first category ID being the category ID of the category as which the target person is classified. Such inclusion of the second category ID in addition to the first category ID in the authentication data enables improved authentication precision by the authentication data.

As described above, the authentication data generated with reference to the input information and the behavior history information in the mobile terminal device 10 are saved into the server 20 as master data. On the other hand, the authentication data are successively updated with reference to latest behavior history information in the mobile terminal device 10. Then, authentication processing on the target person is performed by checking the successively updated authentication data against the master data saved in the server 20.

Update processing on authentication data by the mobile terminal device 10 and authentication processing being related to a target person and using the information processing system 1 will be described below.

### Authentication Data Update Processing

First, a flow of the authentication data update processing by the mobile terminal device 10 will be described with reference to FIG. 11. FIG. 11 is a flowchart illustrating a flow of the authentication data update processing by the mobile terminal device 10.

### Step S31

In Step S31, the mobile terminal device 10 determines whether a predetermined period P2 has elapsed from generation of the previous authentication data. Then, the mobile terminal device 10 advances to Step S32 when determining that the predetermined period P2 has elapsed (YES in Step S31) and repeats the processing in Step S31 otherwise.

The aforementioned predetermined period P2 is a period different from P1 already discussed herein. While not limiting the present example embodiment, specific examples of the aforementioned predetermined period P2 may include a period of about one week and a period of about one day.

### Step S32

In Step S32, the acquisition unit 141 acquires input information stored in the storage unit 16. Then, the acquisition unit 141 supplies the acquired input information to the authentication data generation unit 145.

### Step S33

Next, in Step S33, the acquisition unit 141 acquires latest behavior history information stored in the storage unit 16. Then, the acquisition unit 141 supplies the acquired latest behavior history information to the authentication data generation unit 145.

### Step S34

Next, in Step S34, the authentication data generation unit 145 generates authentication data with reference to the input information acquired in Step S32 and the latest behavior history information acquired in Step S33.

As an example, any of the types of processing described in the authentication data processing example 1 to the authentication data processing example 3 may be used for specific authentication data generation processing in this step, and therefore description thereof is omitted.

### Step S35

Next, in Step S35, the authentication data generation unit 145 stores the authentication data generated in Step S34 into the storage unit 16. While the authentication data generation unit 145 preferably stores the latest authentication data generated in Step S34 by overwriting the already stored authentication data, the present example embodiment is not limited to the above. For example, when storing the latest authentication data without overwriting the already stored authentication data, the authentication data generation unit 145 may be configured to store the latest authentication data with a time stamp indicating a date and time when the latest authentication data are generated in such a way that the latest authentication data can be distinguished from other authentication data.

As described above, the authentication data generation unit 145 generates authentication data for every predetermined period with reference to input information and latest behavior history information in the authentication data update processing. Such periodic update of authentication data by using latest behavior history information by the authentication data update processing enables enhanced security by the authentication processing.

Thus, the storage unit 16 in the mobile terminal device 10 stores latest authentication data for every predetermined period. Note that the steps may be executed in an order other than the illustrated order in the flowchart illustrated in FIG. 11. For example, Step S32 and Step S33 may be executed in an order reverse to the illustrated order.

### Authentication Processing Related to Target Person

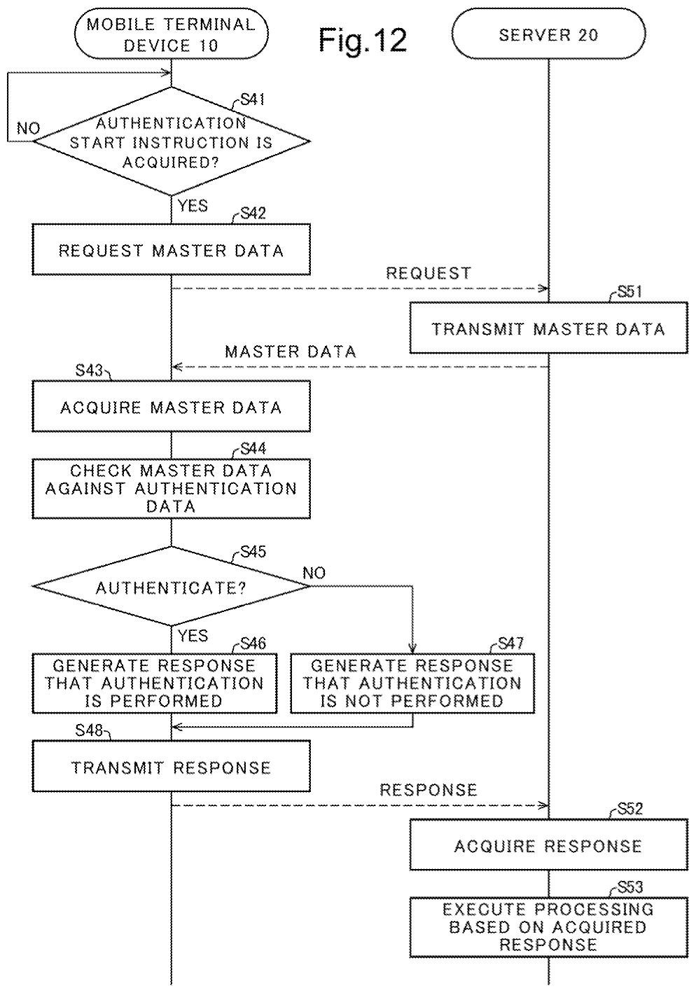

Next, a flow of authentication processing being related to a target person and using the information processing system 1 will be described with reference to FIG. 12. FIG. 12 is a sequence diagram illustrating a flow of the authentication processing being related to a target person and using the information processing system 1.

### Step S41

First, in Step S41, the control unit 14 in the mobile terminal device 10 determines whether the acquisition unit 141 has acquired an authentication start instruction. The control unit 14 advances to Step S42 when the acquisition unit 141 has acquired an authentication start instruction (YES in Step S41) and repeats the processing in Step S41 otherwise (NO in Step S41).

While a timing of and a condition for acquisition of an authentication start instruction do not limit the present example embodiment, examples of such timing and condition may include a service providing server supplying an authentication start instruction when a target person is to receive a service provided by the service providing server. An authentication start instruction may be input by a target person through the acceptance unit 12.

### Step S42

In Step S42, the control unit 14 requests master data from the server 20. More specifically, the control unit 14 transmits a request requesting master data to the server 20 through the communication unit 15.

### Step S51

In Step S51, the control unit 22 in the server 20 acquires the request transmitted in Step S42 through the communication unit 21. Then, the control unit 22 transmits master data stored in the storage unit 16 to the mobile terminal device 10 through the communication unit 21 as a response to the request.

### Step S43

In Step S43, the acquisition unit 141 in the mobile terminal device 10 acquires the master data transmitted in Step S51 through the communication unit 15. Then, the acquisition unit 141 supplies the acquired master data to the checking unit 146.

### Step S44

In Step S44, the checking unit 146 checks the master data acquired in Step S43 against latest authentication data acquired from the storage unit 16 by the acquisition unit 141 and determines consistency between the master data and the authentication data.

As an example, the checking unit 146 compares corresponding items in the master data and the latest authentication data and determines a match for each item. Then, the checking unit 146 refers to the determination result for each item and calculates a matching rate between the master data and the latest authentication data.

The checking unit 146 may be configured to generate inquiry information to the target person when, as a result of the checking processing in this step, the master data is consistent with the authentication data in one part and is not consistent in another part. Then, the presentation unit 11 may be configured to present the generated inquiry information. Further, the aforementioned inquiry information may include, as an inquiry to the target person, questions related to whether changes to the home address, the address of the commuting destination, the travel means, the favorite application, and the like exist.

For example, when a value of the label 4 indicating a result of the branching processing based on a frequently used application during commuting in label information included in the master data is not consistent with a value of the label 4 included in the authentication data and the master data are consistent with the authentication data for the other labels, the checking unit 146 may be configured to generate inquiry information including a question such as “Is the favorite application changed?”

The configuration described above can prompt a target person to be aware of inconsistency between the master data and the authentication data.

### Step S45

In Step S45, the authentication unit 147 determines whether to authenticate the target person with reference to the checking result by the checking unit 146 in Step S43. As an example, the authentication unit 147 authenticates the target person when the matching rate calculated in Step S43 between the master data and the latest authentication data is equal to or more than a predetermined matching rate and does not authenticate the target person otherwise. When authenticating the target person (YES in Step S45), the authentication unit 147 advances to Step S46 and advances to Step S47 otherwise (NO in Step S45).

### Step S46

In Step S46, the authentication unit 147 generates a response that authentication is performed and supplies the response to the communication unit 15.

### Step S47

In Step S47, the authentication unit 147 generates a response that authentication is not performed and supplies the response to the communication unit 15.

### Step S48

In Step S48, the communication unit 15 transmits the response generated in Step S46 or Step S47.

### Step S52

In Step S52, the control unit 22 in the server 20 acquires the response transmitted in Step S48 through the communication unit 21.

### Step S53

In Step S53, the control unit 22 in the server 20 executes processing based on the acquired response. As an example, when acquiring the response that authentication is performed, the control unit 22 transmits information that a service is provided for the target person to a service providing server; and when acquiring the response that authentication is not performed, the control unit 22 transmits information that the service is not provided for the target person to the service providing server.

As described above, according to the present example embodiment, master data and authentication data that are referred to in the checking processing are generated with reference to behavior history information indicating a behavior history of a target person and input information indicating an input content input in response to a question related to a behavior of the target person. Accordingly, the information processing system 1 configured as described above can provide an authentication technology reducing an amount of processing while enhancing convenience and security.

### Supplementary Item 1 of First Example Embodiment

While a configuration in which the authentication data generation unit 145 executes the classification processing in Step S152 has been described in the example described above, the present example embodiment is not limited to the above. For example, a configuration in which the representative value determined in Step S151 and the latest behavior history information acquired by the acquisition unit 141 in Step S14 are transmitted to the server 20 or another information processing device through the communication unit 15, the server 20 or the another information processing device executes the classification processing in Step S152, and the authentication data generation unit 145 acquires the classification result, may be employed.

Similarly, a configuration in which the consistency confirmation processing in Step S153 is executed by the server 20 or another information processing device and the authentication data generation unit 145 acquires the consistency confirmation result may be employed.

The configurations as described above also provide effects similar to those provided by the aforementioned example embodiment.

### Supplementary Item 2 of First Example Embodiment

The authentication data generation unit 145 may be configured to present generated authentication data or generated master data to a target person through the presentation unit 11. Further, the authentication data generation unit 145 may be configured to present the authentication data or the master data to the target person and then accept an input related to whether to employ the authentication data or the master data from the target person through the acceptance unit 12. In this configuration, processing using the employed authentication data or master data is continued when an input that the data are employed is accepted; and the authentication data or the master data are discarded when an input that the data are not employed is accepted.

With the configuration described above, the information processing system 1 performs the checking and authentication processing by using authentication data or master data employed by a target person and therefore improves security by the authentication processing.

### Supplementary Item 3 of First Example Embodiment

Authentication data generated by the authentication data generation unit 145 may be independently used for authentication without being shared with another authentication method or may be used for authentication in combination with other authentication methods such as face authentication, fingerprint authentication, voiceprint authentication, and bloodstream authentication. Combination with other authentication methods enables improvement in security by the authentication processing.

While the method of generating authentication data combined with other authentication methods as described above does not limit the present example embodiment, examples of the method include the following.

For example, when fingerprint authentication is combined, the mobile terminal device 10 may be configured to include an unillustrated fingerprint scanner and a fingerprint information generation unit generating fingerprint information indicating a feature of a fingerprint scanned by the fingerprint scanner, and the fingerprint information may be included into master data and authentication data that are generated by the authentication data generation unit 145.

Further, the checking processing by the checking unit 146 may include processing of checking fingerprint information included in master data against fingerprint information included in latest authentication data.

### Supplementary Item 4 of First Example Embodiment

The acquisition unit 141 included in the control unit 14 may be configured to acquire further information about a behavior of the target person from an acquisition source different from an acquisition source of input information, and the authentication data generation unit 145 may be configured to generate authentication data related to the target person with reference to the behavior history information, the input information, and the further information.

As an example, the acquisition unit 141 may be configured to acquire further information about a behavior of a target person from a commuting destination server being a server managed at a commuting destination to which the target person belongs, and the authentication data generation unit 145 may be configured to generate authentication data with reference to the further information. For example, the acquisition unit 141 may be configured to acquire at least one type of information out of

information such as a school year, a faculty, a department, and a selected class of the target person and

information such as an organization and a team to which the target person belongs

from the commuting destination server and generate authentication data with reference to the acquired information.

The configuration described above generates authentication data with reference to further information about a behavior of the target person and therefore improves precision of the authentication processing relate d to the target person.

Further, the acquisition unit 141 may be configured to acquire a part or the whole of input information indicating an input content input in response to a question related to a behavior of the target person from the commuting destination server. The configuration saves time and effort for input by the target person and therefore improves convenience.

### Second Example Embodiment

Another example embodiment of the present invention will be described below. Note that, for convenience of description, a component having the same function as that of a component described in the aforementioned example embodiment is given the same sign, and thus duplicated description thereof is omitted.

### Schematic Configuration of Information Processing System 2

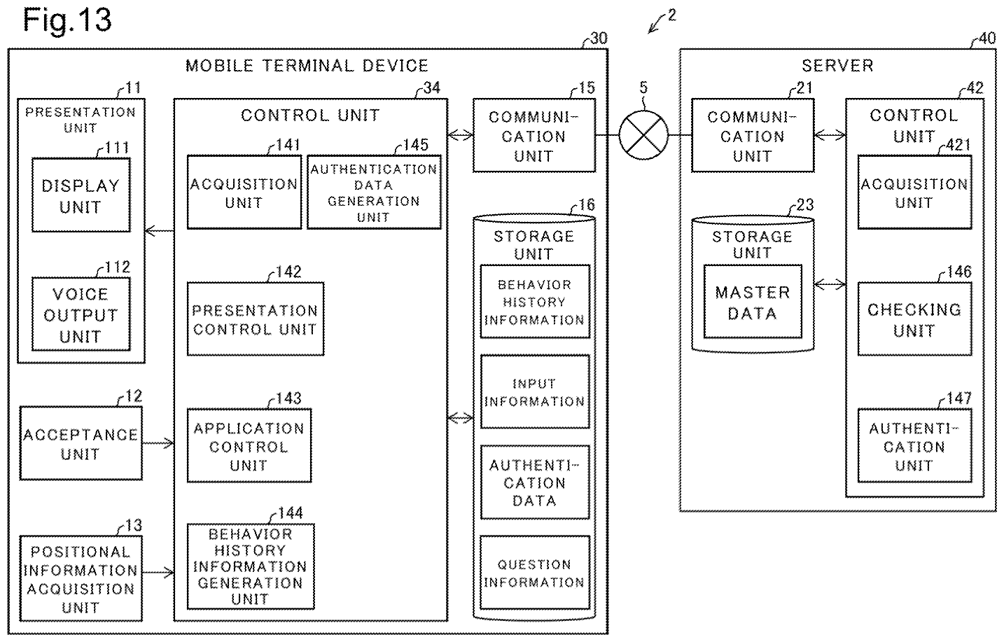

First, a configuration of an information processing system 2 according to the present example embodiment will be described with reference to FIG. 13. FIG. 13 is a block diagram illustrating an example of a main configuration of the information processing system 2 according to the present example embodiment. The information processing system 2 is configured to include a plurality of information processing devices; and as an example, the information processing system 2 is configured to include a mobile terminal device 30 being an information processing device and a server 40 being an information processing device, as illustrated in FIG. 13. Further, the mobile terminal device 30 and the server 40 are configured to be communicable with each other through a network 5.

While one mobile terminal device is illustrated in FIG. 13 as an example, the present example embodiment is not limited to the above, and the information processing system 2 may be configured to include a plurality of mobile terminal devices each configured similarly to the mobile terminal device 30.

As an example, the mobile terminal device 30 includes a presentation unit 11, an acceptance unit 12, a positional information acquisition unit 13, a communication unit 15, and a storage unit 16, as illustrated in FIG. 13. Further, the mobile terminal device 30 includes a control unit 34 in place of the control unit 14 included in the mobile terminal device 10 according to the first example embodiment. As illustrated in FIG. 13, the control unit 34 is configured similarly to the control unit 14 except for not including the checking unit 146 and the authentication unit 147.

Further, as an example, the server 40 includes a communication unit 21 and a storage unit 23, as illustrated in FIG. 13. Further, the server 40 includes a control unit 42 in place of the control unit 22 included in the server 20 according to the first example embodiment. The control unit 42 includes an acquisition unit 421, a checking unit 146, and an authentication unit 147, as illustrated in FIG. 13.

Thus, the information processing system 2 according to the present example embodiment differs from the information processing system 1 according to the first example embodiment in including the checking unit 146 and the authentication unit 147 in the server instead of the mobile terminal device.

In the information processing system 2,

master data generation and storage processing,

authentication data generation processing, and

authentication data update processing
are performed similarly to the processing in the first example embodiment, and therefore description thereof is omitted. On the other hand, authentication processing related to a target person is different from that in the first example embodiment as described below.

### Authentication Processing Related to Target Person

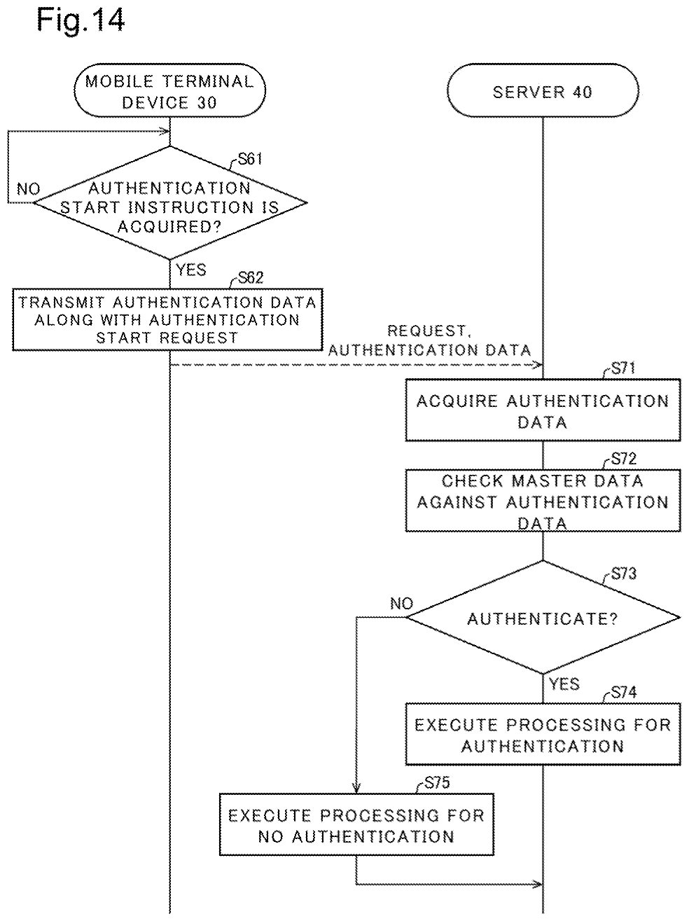

A flow of the authentication processing being related to a target person and using the information processing system 2 will be described below with reference to FIG. 14. FIG. 14 is a sequence diagram illustrating a flow of the authentication processing being related to a target person and using the information processing system 2.

### Step S61

First, in Step S41, the control unit 34 in the mobile terminal device 30 determines whether the acquisition unit 141 has acquired an authentication start instruction. The control unit 34 advances to Step S62 when the acquisition unit 141 has acquired an authentication start instruction (YES in Step S61) and repeats the processing in Step S61 otherwise (NO in Step S61). The processing in this step is similar to that in Step S41 in the first example embodiment.

### Step S62

In Step S62, the control unit 34 transmits latest authentication data stored in the storage unit 16 to the server 40 through the communication unit 15 along with the authentication start request.

### Step S71

In Step S71, the acquisition unit 421 included in the control unit 42 in the server 40 acquires the request transmitted in Step S62 through the communication unit 21. The acquisition unit 421 supplies the acquired authentication data to the checking unit 146.

### Step S72

In Step S72, the checking unit 146 checks the authentication data acquired in Step S71 against master data acquired from the storage unit 16 by the acquisition unit 421. Specific checking processing by the checking unit 146 has been described in the first example embodiment, and therefore description thereof is omitted.

### Step S73

In Step S73, the authentication unit 147 determines whether to authenticate the target person with reference to the checking result by the checking unit 146 in Step S72. Specific authentication processing by the authentication unit 147 has been described in the first example embodiment, and therefore description thereof is omitted. The authentication unit 147 advances to Step S74 when authenticating the target person (YES in Step S73) and advances to Step S75 otherwise (NO in Step S73).

### Step S74

In Step S74, the control unit 42 executes processing for the case of authenticating the target person. A specific processing content in the case of authentication has been described in the first example embodiment, and therefore description thereof is omitted.

### Step S75

In Step S75, the control unit 42 executes processing for the case of not authenticating the target person. A specific processing content in the case of authentication has been described in the first example embodiment, and therefore description thereof is omitted.

As described above, while the checking and authentication processing is performed by the server 40, according to the present example embodiment, master data and authentication data referred to in the checking processing are generated with reference to behavior history information indicating a behavior history of the target person and input information indicating an input content input in response to a question related to a behavior of the target person, similarly to the first example embodiment. Accordingly, the information processing system 2 configured as described above can provide an authentication technology reducing an amount of processing while enhancing convenience and security, similarly to the information processing system 1 according to the first example embodiment.

### Third Example Embodiment

Another example embodiment of the present invention will be described below. Note that, for convenience of description, a component having the same function as that of a component described in the aforementioned example embodiment is given the same sign, and thus duplicated description thereof is omitted.

### Schematic Configuration of Information Processing System 3

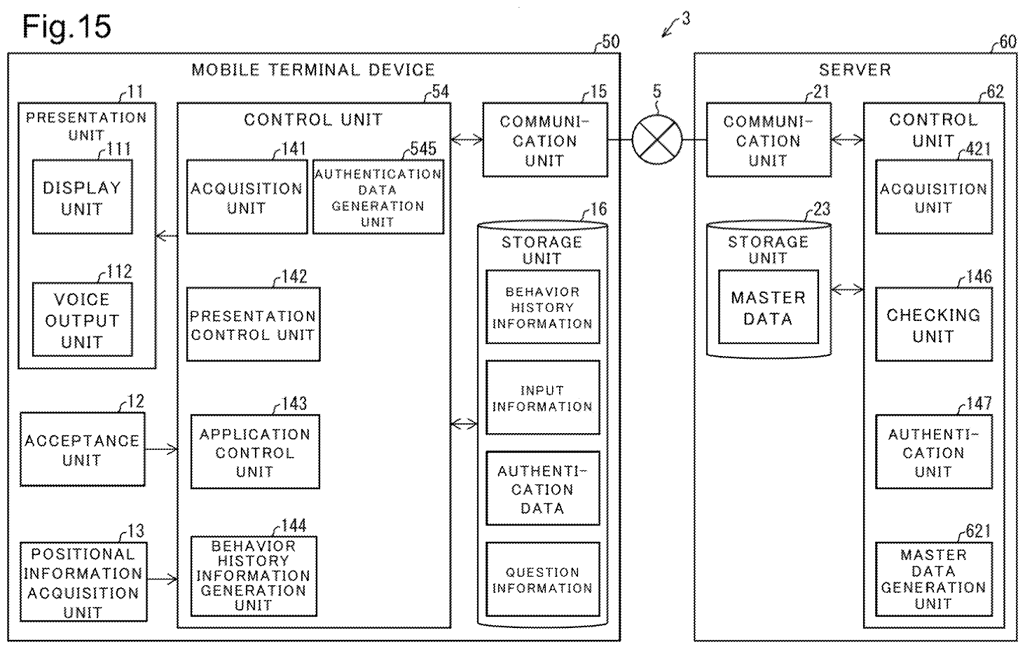

First, a configuration of an information processing system 3 according to the present example embodiment will be described with reference to FIG. 15. FIG. 15 is a block diagram illustrating an example of a main configuration of the information processing system 3 according to the present example embodiment. The information processing system 3 is configured to include a plurality of information processing devices; and as an example, the information processing system 3 is configured to include a mobile terminal device 50 being an information processing device and a server 60 being an information processing device, as illustrated in FIG. 15. Further, the mobile terminal device 50 and the server 60 are configured to be communicable with each other through the network 5.

Further, while one mobile terminal device is illustrated in FIG. 15 as an example, the present example embodiment is not limited to the above, and the information processing system 3 may be configured to include a plurality of mobile terminal devices each configured similarly to the mobile terminal device 30.

As an example, the mobile terminal device 50 includes a presentation unit 11, an acceptance unit 12, a positional information acquisition unit 13, a communication unit 15, and a storage unit 16, as illustrated in FIG. 15. Further, the mobile terminal device 50 includes a control unit 54 in place of the control unit 34 included in the mobile terminal device 30 according to the second example embodiment. The control unit 54 is configured similarly to the control unit 34 except for including an authentication data generation unit 545 in place of the authentication data generation unit 145 according to the second example embodiment, as illustrated in FIG. 15.

The authentication data generation unit 545 is configured similarly to the authentication data generation unit 145 according to the first and second example embodiments except for not generating master data.

Further, as an example, the server 60 includes a communication unit 21 and a storage unit 23, as illustrated in FIG. 15. Further, the server 60 includes a control unit 62 in place of the control unit 22 included in the server 40 according to the second example embodiment. The control unit 62 includes a master data generation unit 621 in addition to the configuration included in the control unit 42 according to the second example embodiment, as illustrated in FIG. 15.

The master data generation unit 621 generates master data with reference to input information acquired from the mobile terminal device 50 and latest behavior history information, as will be described later.

Thus, the information processing system 3 according to the present example embodiment differs from the information processing system 2 according to the second example embodiment in that an authentication data generation unit in the mobile terminal device does not generate master data and that the server includes the master data generation unit 621.

In the information processing system 3,

authentication data generation processing,

authentication data update processing, and

authentication processing related to a target person

are performed similarly to the processing in the second example embodiment, and therefore description thereof is omitted. On the other hand, as will be described below, master data generation and storage processing is different from that in the first and second example embodiments.

### Master Data Generation and Storage Processing

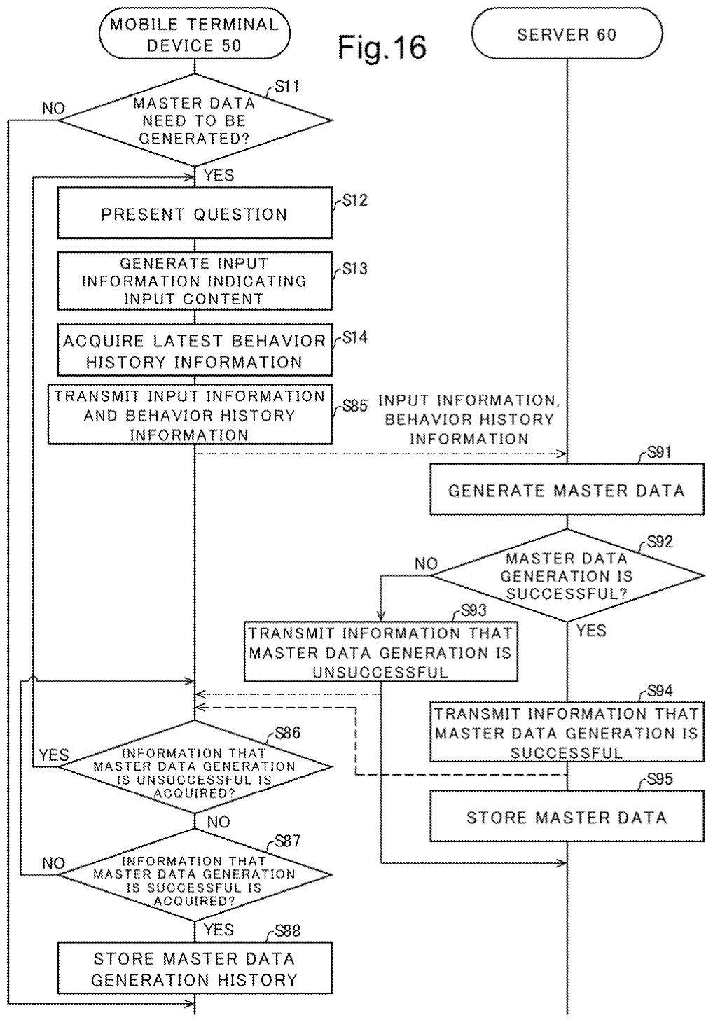

A flow of the master data generation and storage processing using the information processing system 3 will be described below with reference to FIG. 16. FIG. 16 is a sequence diagram illustrating a flow of the master data generation and storage processing using the information processing system 3.

### Step S11 to Step S14

Step S11 to Step S14 are similar to the processing described with reference to FIG. 3 in the first example embodiment, and therefore description thereof is omitted.

### Step S85

In Step S85, the control unit 54 transmits input information acquired in Step S13 and latest behavior history information acquired in Step S14 to the server 60 through the communication unit 15.

### Step S91

Next, in Step S91, the control unit 62 in the server 60 acquires, through the communication unit 21, the input information and the latest behavior history information that are transmitted from the communication unit 15. Then, the master data generation unit 621 in the control unit 62 generates master data with reference to the acquired input information and the acquired latest behavior history information. Specific master data generation processing in this step is similar to the processing by the authentication data generation unit 145 according to the first and second example embodiments, and therefore description thereof is omitted.

### Step S92

Next, in Step S92, the master data generation unit 621 determines whether generation of master data in Step S91 is successful, advances to Step S94 when the generation is successful (YES in Step S92), and advances to Step S93 otherwise (NO in Step S92).

### Step S93

When generation of master data is unsuccessful, the control unit 62 transmits information to the effect that master data generation is unsuccessful to the mobile terminal device 50 through the communication unit 21 in Step S93.

### Step S94

When generation of master data is successful, the control unit 62 transmits information to the effect that master data generation is successful to the mobile terminal device 50 through the communication unit 21 in Step S94. The information to the effect that master data generation is successful may include a time stamp indicating a date and time when the master data are generated.

### Step S95

When generation of master data is successful, the control unit 62 stores the master data generated in Step S91 into the storage unit 23 in Step S95.

### Step S86

In Step S86, the control unit 50 in the mobile terminal device 50 determines whether information to the effect that master data generation is unsuccessful is received. Then, when information to the effect that master data generation is unsuccessful is received, the control unit 50 returns to Step S12, presents a question again, and then accepts input from the target person again. Re-presentation of the question in the aforementioned processing has been described with reference to FIG. 4 and the like in the first example embodiment, and therefore description thereof is omitted.

### Step S87

In Step S87, the control unit 50 in the mobile terminal device 50 determines whether information to the effect that master data generation is successful is received. Then, the control unit 50 advances to Step S88 when information to the effect that master data generation is successful is received and returns to before Step S86 otherwise.

### Step S88

When receiving information to the effect that master data generation is successful, the control unit 54 in the mobile terminal device 50 stores information to the effect that master data are already generated into the storage unit 16 as a master data generation history in Step S88. The master data generation history may include a time stamp indicating a date and time when the master data are generated.

As described above, while the master data generation and storage processing are performed by the server 60, according to the present example embodiment, master data and authentication data that are referred to in the checking processing are generated with reference to behavior history information indicating a behavior history of a target person and input information indicating an input content input in response to a question related to a behavior of the target person, similarly to the first and second example embodiments. Accordingly, the information processing system 3 as configured above can provide an authentication technology reducing an amount of processing while enhancing convenience and security, similarly to the information processing systems 1 and 2 according to the first and second example embodiments.

### Supplementary Item of Third Example Embodiment

While an example of executing the authentication data generation processing in the mobile terminal device 50 and performing the master data generation processing, the checking processing, and the authentication processing in the server 60 has been described in the present example embodiment, the above does not limit the example embodiments described herein.

As an example, the server 60 may be configured to include the authentication data generation unit 545 and execute all of the authentication data generation processing, the master data generation processing, the checking processing, and the authentication processing. In this configuration, the communication unit 15 in the mobile terminal device 50 may transmit input information and latest behavior history information to the server 60, and the authentication data generation unit 545 and the master data generation unit 621 that are included in the server 60 may generate authentication data and master data. Then, the checking unit 146 may perform checking on the data, and the authentication unit 147 may perform authentication, based on the result. Such a configuration also provides effects similar to those provided by the aforementioned example embodiments.

### Fourth Example Embodiment

Another example embodiment of the present invention will be described below. Note that, for convenience of description, a component having the same function as that of a component described in the aforementioned example embodiment is given the same sign.

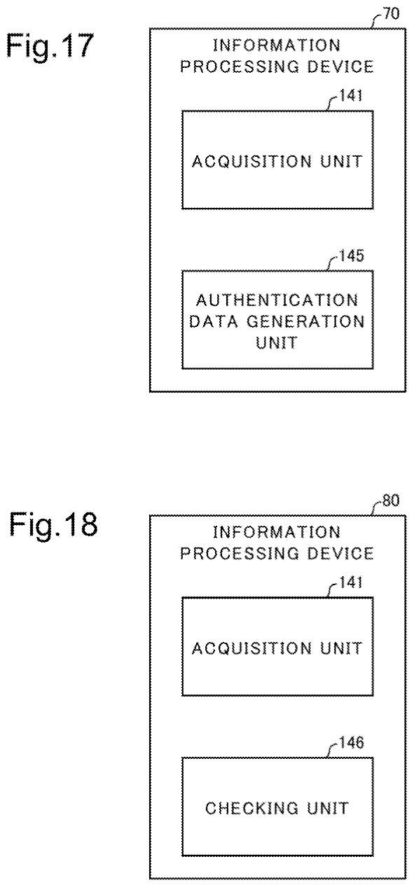

FIG. 17 is a block diagram illustrating a configuration of an information processing device 70 according to the present example embodiment. As illustrated in FIG. 17, the information processing device 70 includes an acquisition unit 141 and an authentication data generation unit 145.

The acquisition unit 141 acquires behavior history information indicating a behavior history of a target person and input information indicating an input content input in response to a question related to a behavior of the target person.

The authentication data generation unit 145 generates authentication data related to the target person with reference to the behavior history information and the input information.

With the configuration described above, the authentication data generation unit 145 generates authentication data related to a target person with reference to behavior history information indicating a behavior history of the target person and input information indicating an input content input in response to a question related to a behavior of the target person, and therefore an authentication technology reducing an amount of processing with enhancing convenience and security can be provided.

### Fifth Example Embodiment

Another example embodiment of the present invention will be described below. Note that, for convenience of description, a component having the same function as that of a component described in the aforementioned example embodiment is given the same sign.

FIG. 18 is a block diagram illustrating a configuration of an information processing device 80 according to the present example embodiment. As illustrated in FIG. 18, the information processing device 80 includes an acquisition unit 141 and a checking unit 146.

The acquisition unit 141 acquires first authentication data and second authentication data, the first authentication data being master data being related to a target person and being generated with reference to behavior history information indicating a behavior history of the target person at a past certain point in time and input information input in response to a question related to a behavior of the target person, and the second authentication data being related to a target person and being generated with reference to the input information and behavior history information indicating a behavior history of the target person at a point in time later than the certain point in time.

The checking unit 146 checks the first authentication data against the second authentication data.

With the configuration described above, the checking unit 146 checks first authentication data against second authentication data, the first authentication data being master data being related to a target person and being generated with reference to behavior history information indicating a behavior history of the target person at a past certain point in time and input information input in response to a question related to a behavior of the target person, and the second authentication data being related to a target person and being generated with reference to the input information and behavior history information indicating a behavior history of the target person at a point in time later than the certain point in time; and therefore an authentication technology reducing an amount of processing with enhancing convenience and security can be provided.

### Sixth Example Embodiment

Another example embodiment of the present invention will be described below. Note that, for convenience of description, a component having the same function as that of a component described in the aforementioned example embodiment is given the same sign.

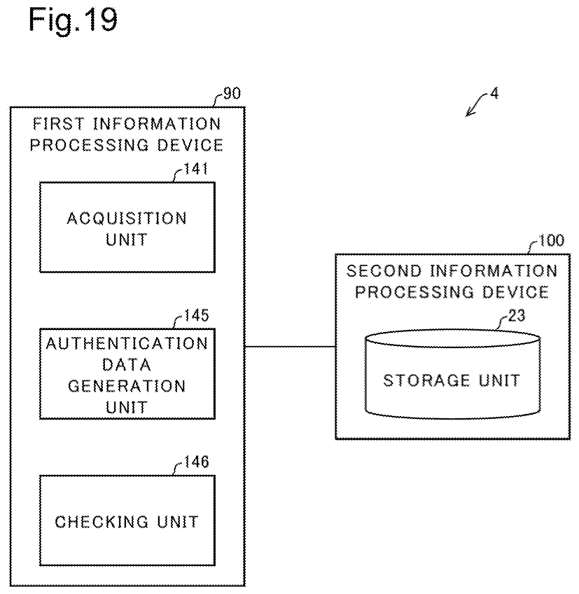

FIG. 19 is a block diagram illustrating a configuration of an information processing system 4 according to the present example embodiment. As illustrated in FIG. 19, the information processing system 4 includes a first information processing device 90 and a second information processing device 100 that are communicably connected to each other.

Further, as illustrated in FIG. 19, the first information processing device 90 includes an acquisition unit 141, an authentication data generation unit 145, and a checking unit 146.

The acquisition unit 141 acquires behavior history information indicating a behavior history of a target person and input information indicating an input content input in response to a question related to a behavior of the target person.

The authentication data generation unit 145 generates authentication data related to the target person with reference to the behavior history information and the input information.

On the other hand, the second information processing device 100 includes a storage unit 23, as illustrated in FIG. 19. The storage unit 23 stores first authentication data being related to the target person and being generated by the authentication data generation unit 145 with reference to behavior history information indicating a behavior history of the target person at a past certain point in time and input information being an input content input in response to a question related to a behavior of the target person.

Further, the first information processing device 90 acquires, by the acquisition unit 141, the first authentication data and second authentication data being related to a target person and being generated by the authentication data generation unit 145 with reference to the input information and behavior history information indicating a behavior history of the target person at a point in time later than the certain point in time. Further, the first information processing device 90 includes the checking unit 146, and the checking unit 146 checks the first authentication data against the second authentication data.

With the configuration described above, an authentication technology reducing an amount of processing while enhancing convenience and security can be provided.

### Example Provided by Hardware Configuration and Software

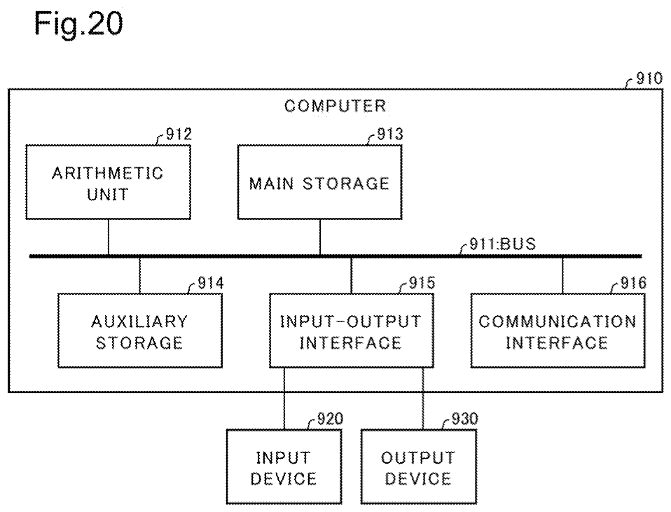

Each control block in the mobile terminal devices 10, 30, and 50, the servers 20, 40, and 60, the information processing devices 70 and 80, the first information processing device 90, and the second information processing device 100 (each unit included in the control units 14, 34, 54, 22, 42, and 62 in particular) may be provided by a logic circuit (hardware) in a form on an integrated circuit (IC chip) or the like or may be provided by software by using a central processing unit (CPU). In the latter case, each of the mobile terminal devices 10, 30, and 50, the servers 20, 40, and 60, the information processing devices 70 and 80, the first information processing device 90, and the second information processing device 100 can be configured by using a computer (electronic computer) as illustrated in FIG. 20.

FIG. 20 is a block diagram illustrating a configuration of a computer 910 usable as the mobile terminal devices 10, 30, and 50, the servers 20, 40, and 60, the information processing devices 70 and 80, the first information processing device 90, and the second information processing device 100. The computer 910 includes an arithmetic unit 912, a main storage 913, an auxiliary storage 914, and an input-output interface 915 that are interconnected through a bus 911. For example, the arithmetic unit 912, the main storage 913, and the auxiliary storage 914 may be a CPU, a random access memory (RAM), and a hard disk drive, respectively. The input-output interface 915 is connected to an input device 920 for a user to input various types of information to the computer 910, and an output device 930 for the computer 910 to output various types of information to the user. The input device 920 and the output device 930 may be built into the computer 910 or may be connected (externally attached) to the computer 910. Examples of the input device 920 may include a keyboard, a mouse, and a touch sensor, and examples of the output device 930 may include a display, a printer, and a speaker. Further, a device having functions of both the input device 920 and the output device 930, such as a touch panel into which a touch sensor and a display are integrated, may be applied. Then, a communication interface 916 is an interface for communication between the computer 910 and an external device.

The auxiliary storage 914 stores an information processing program for causing the computer 910 to operate as the mobile terminal devices 10, 30, and 50, the servers 20, 40, and 60, the information processing devices 70 and 80, the first information processing device 90, and the second information processing device 100. Then, the arithmetic unit 912 causes the computer 910 to function as the units included in the mobile terminal devices 10, 30, and 50, the servers 20, 40, and 60, the information processing devices 70 and 80, the first information processing device 90, and the second information processing device 100 by loading the aforementioned information processing program stored in the auxiliary storage 914 into the main storage 913 and executing instructions included in the information processing program. A recording medium used by the auxiliary storage 914 for recording information such as the information processing program has only to be a computer-readable “non-transitory tangible medium;” and examples of such a medium may include a tape, a disk, a card, a semiconductor memory, and a programmable logic circuit.

Further, a configuration causing the computer 910 to function by using a program recorded on a recording medium external to the computer 910 or a program supplied to the computer 910 through any transmission medium (such as a communication network or a broadcast wave) may be employed. Then, the present invention may be provided in a form of a data signal embedded in a carrier wave, the form materializing the aforementioned program by electronic transmission.

The present invention is not limited to the aforementioned example embodiments, and various changes and modifications may be made within the scope of the invention described in the claims; and example embodiments acquired by appropriately combining technical means disclosed in different example embodiments are also included in the technical scope of the present invention.

### Supplementary Notes

The whole or part of the example embodiments disclosed above can be described as, but not limited to, the following supplementary notes.

### Supplementary Note 1

An information processing device including:

an acquisition unit acquiring behavior history information indicating a behavior history of a target person and input information indicating an input content input in response to a question related to a behavior of the target person; and

an authentication data generation unit generating authentication data related to the target person with reference to the behavior history information and the input information.

### Supplementary Note 2

The information processing device according to Supplementary Note 1, wherein

the authentication data generated by the authentication data generation unit include classification information acquired with reference to the input information.

### Supplementary Note 3

The information processing device according to Supplementary Note 2, wherein

the classification information includes at least one type of information out of
label information indicating a content of at least one of one or more items included in the input information and
category information indicating a category as which the target person is classified.

### Supplementary Note 4

The information processing device according to any one of Supplementary Notes 1 to 3, wherein

generation processing of the authentication data by the authentication data generation unit includes processing of confirming consistency between the input information and the behavior history information.

### Supplementary Note 5

The information processing device according to Supplementary Note 4, wherein

the authentication data generation unit generates authentication data not including the behavior history information.

### Supplementary Note 6

The information processing device according to any one of Supplementary Notes 1 to 4, wherein

the authentication data generation unit executes reduction processing of deleting at least part of information specified by one of one or more items included in the input information from the behavior history information and includes behavior history information after the reduction processing into the authentication data.

### Supplementary Note 7

The information processing device according to any one of Supplementary Notes 1 to 6, wherein

the authentication data generation unit generates authentication data for every predetermined period with reference to the input information and latest behavior history information.

### Supplementary Note 8

The information processing device according to any one of Supplementary Notes 1 to 7, wherein

the input information includes information indicating at least one of a starting point, a transfer point, and an ending point of travel related to the target person, and each type of means for travel.

### Supplementary Note 9

The information processing device according to any one of Supplementary Notes 1 to 8, wherein

the acquisition unit acquires
first authentication data being related to a target person and being generated with reference to behavior history information indicating a behavior history of the target person at a past certain point in time and input information indicating an input content input in response to a question related to a behavior of the target person and
second authentication data being related to a target person and being generated by the authentication data generation unit with reference to behavior history information indicating a behavior history of the target person at a point in time later than the certain point in time and the input information, and

the information processing device includes

a checking unit executing checking processing of checking the first authentication data against the second authentication data.

### Supplementary Note 10

The information processing device according to Supplementary Note 9, wherein

the checking unit generates inquiry information to the target person when, as a result of the checking processing, a part of the first authentication data is consistent with the second authentication data and another part is not consistent.

### Supplementary Note 11

The information processing device according to any one of Supplementary Notes 1 to 10, wherein

the acquisition unit acquires further information about a behavior of the target person from an acquisition source different from an acquisition source of the input information, and

the authentication data generation unit generates authentication data related to the target person with reference to the behavior history information, the input information, and the further information.

### Supplementary Note 12

The information processing device according to any one of Supplementary Notes 1 to 11, further including:

a presentation unit presenting the question to the target person; and

an acceptance unit accepting an input content from the target person and generating the input information from the input content.

### Supplementary Note 13

An information processing device including an acquisition unit and a checking unit, wherein

the acquisition unit acquires
first authentication data being related to a target person and being generated with reference to behavior history information indicating a behavior history of the target person at a past certain point in time and input information input in response to a question related to a behavior of the target person and
second authentication data being related to a target person and being generated with reference to behavior history information indicating a behavior history of the target person at a point in time later than the certain point in time and the input information, and

the checking unit checks the first authentication data against the second authentication data.

### Supplementary Note 14

An information processing system including a first information processing device and a second information processing device that are communicably connected to each other, wherein

the first information processing device includes:
an acquisition unit acquiring behavior history information indicating a behavior history of a target person and input information indicating an input content input in response to a question related to a behavior of the target person; and
an authentication data generation unit generating authentication data related to the target person with reference to the behavior history information and the input information,

the second information processing device includes
a storage unit storing first authentication data being related to the target person and being generated by the authentication data generation unit with reference to behavior history information indicating a behavior history of the target person at a past certain point in time and input information indicating an input content input in response to a question related to a behavior of the target person, and

the first information processing device
acquires, by the acquisition unit,
   the first authentication data and
   second authentication data being related to a target person and being generated by the authentication data generation unit with reference to behavior history information indicating a behavior history of the target person at a point in time later than the certain point in time and the input information and
further includes a checking unit checking the first authentication data against the second authentication data.

### Supplementary Note 15

An information processing method including:

an acquisition step of acquiring behavior history information indicating a behavior history of a target person and input information indicating an input content input in response to a question related to a behavior of the target person; and

a generation step of generating authentication data related to the target person with reference to the behavior history information and the input information.

### Supplementary Note 16

An information processing method including an acquisition step and a checking step, wherein,

in the acquisition step,
first authentication data being related to a target person and being generated with reference to behavior history information indicating a behavior history of the target person at a past certain point in time and input information indicating an input content input in response to a question related to a behavior of the target person and
second authentication data being related to a target person and being generated with reference to behavior history information indicating a behavior history of the target person at a point in time later than the certain point in time and the input information

are acquired, and,

in the checking step, the first authentication data are checked against the second authentication data.

### Supplementary Note 17

The information processing device according to each aspect of the present invention may be provided by a computer; and in this case, by causing the computer to operate as each unit (software component) included in the information processing device, an information processing program causing the computer to provide the information processing device and a computer-readable recording medium having the information processing program recorded thereon also fall under the category of the present invention.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Japanese patent application No. 2020-056503, filed on Mar. 26, 2020, the disclosure of which is incorporated herein in its entirety by reference.

### REFERENCE SIGNS LIST

1, 2, 3, 4 Information processing system
10, 30, 50 Mobile terminal device (Information processing device)
20, 40, 60 Server (Information processing device)
70, 80, 90, 100 Information processing device
141, 421 Acquisition unit
145 Authentication data generation unit
146 Checking unit
16, 23 Storage unit

What is claimed is:

1. An information processing device comprising:
an acquisition unit configured to acquire behavior history information indicating a behavior history of a target person and input information indicating an input content input in response to a question related to a behavior of the target person; and
an authentication data generation unit configured to generate authentication data related to the target person with reference to the behavior history information and the input information.

2. The information processing device according to claim 1, wherein
the authentication data generated by the authentication data generation unit includes classification information acquired with reference to the input information.

3. The information processing device according to claim 2, wherein
the classification information includes at least one type of information out of
label information indicating a content of at least one of one or more items included in the input information and
category information indicating a category as which the target person is classified.

4. The information processing device according to claim 1, wherein
generation processing of the authentication data by the authentication data generation unit includes processing of confirming consistency between the input information and the behavior history information.

5. The information processing device according to claim 4, wherein
the authentication data generation unit generates authentication data not including the behavior history information.

6. The information processing device according to claim 1, wherein
the authentication data generation unit executes reduction processing of deleting at least part of information specified by one of one or more items included in the input information from the behavior history information and includes behavior history information after the reduction processing into the authentication data.

7. The information processing device according to claim 1, wherein
the authentication data generation unit generates authentication data for every predetermined period with reference to the input information and latest behavior history information.

8. The information processing device according to claim 1, wherein
the input information includes information indicating at least one of a starting point, a transfer point, and an ending point of travel related to the target person, and each type of means for travel.

9. The information processing device according to claim 1, wherein
the acquisition unit acquires
first authentication data being related to a target person and being generated with reference to behavior history information indicating a behavior history of the target person at a past certain point in time and input information indicating an input content input in response to a question related to a behavior of the target person and
second authentication data being related to a target person and being generated by the authentication data generation unit with reference to behavior history information indicating a behavior history of the target person at a point in time later than the certain point in time and the input information, and
the information processing device includes
a checking unit configured to execute checking processing of checking the first authentication data against the second authentication data.

10. The information processing device according to claim 9, wherein
the checking unit generates inquiry information to the target person when, as a result of the checking processing, a part of the first authentication data is consistent with the second authentication data and another part is not consistent.

11. The information processing device according to claim 1, wherein
the acquisition unit acquires further information about a behavior of the target person from an acquisition source different from an acquisition source of the input information, and
the authentication data generation unit generates authentication data related to the target person with reference to the behavior history information, the input information, and the further information.

12. The information processing device according to claim 1, further comprising:
a presentation unit configured to present the question to the target person; and
an acceptance unit configured to accept an input content from the target person and generate the input information from the input content.

13. (canceled)

14. An information processing system comprising a first information processing device and a second information processing device that are communicably connected to each other, wherein
the first information processing device includes:
an acquisition unit configured to acquire behavior history information indicating a behavior history of a target person and input information indicating an input content input in response to a question related to a behavior of the target person; and
an authentication data generation unit configured to generate authentication data related to the target person with reference to the behavior history information and the input information,
the second information processing device includes
a storage unit configured to store first authentication data being related to the target person and being generated by the authentication data generation unit with reference to behavior history information indicating a behavior history of the target person at a past certain point in time and input information indicating an input content input in response to a question related to a behavior of the target person, and
the first information processing device
acquires, by the acquisition unit,
the first authentication data and
second authentication data being related to a target person and being generated by the authentication data generation unit with reference to behavior history information indicating a behavior history of the target person at a point in time later than the certain point in time and the input information and
further includes a checking unit configured to check the first authentication data against the second authentication data.

15. An information processing method comprising:
acquiring behavior history information indicating a behavior history of a target person and input information indicating an input content input in response to a question related to a behavior of the target person; and
generating authentication data related to the target person with reference to the behavior history information and the input information.

16.-18. (canceled)

19. The information processing device according to claim 2, wherein
generation processing of the authentication data by the authentication data generation unit includes processing of confirming consistency between the input information and the behavior history information.

20. The information processing device according to claim 3, wherein
generation processing of the authentication data by the authentication data generation unit includes processing of confirming consistency between the input information and the behavior history information.

21. The information processing device according to claim 2, wherein
the authentication data generation unit executes reduction processing of deleting at least part of information specified by one of one or more items included in the input information from the behavior history information and includes behavior history information after the reduction processing into the authentication data.

22. The information processing device according to claim 3, wherein
the authentication data generation unit executes reduction processing of deleting at least part of information specified by one of one or more items included in the input information from the behavior history information and includes behavior history information after the reduction processing into the authentication data.

23. The information processing device according to claim 4, wherein
the authentication data generation unit executes reduction processing of deleting at least part of information specified by one of one or more items included in the input information from the behavior history information and includes behavior history information after the reduction processing into the authentication data.

24. The information processing device according to claim 2, wherein
the authentication data generation unit generates authentication data for every predetermined period with reference to the input information and latest behavior history information.
